(19) United States
(12) Patent Application Publication
(10) Pub. No.: US 2025/0378344 A1
(43) Pub. Date: Dec. 11, 2025

(54) FINE-TUNING DOMAIN-SPECIFIC LARGE LANGUAGE MODEL USING REASONING DISTILLATION TO MITIGATE CATASTROPHIC FORGETTING

(71) Applicant: Microsoft Technology Licensing, LLC, Redmond, WA (US)

(72) Inventors: Praveen Kumar Bodigutla, San Jose, CA (US); Sai Vivek Kanaparthy, Dublin, CA (US); Ashvini Kumar Jindal, San Francisco, CA (US); Siyu Zhu, Mountain View, CA (US); Jie Bing, Campbell, CA (US)

(21) Appl. No.: 18/737,574

(22) Filed: Jun. 7, 2024

(51) Int. Cl. G06N 3/091

(52) U.S. Cl. CPC G06N 3/091

(57) ABSTRACT

Embodiments of the disclosed technologies are capable of training a large language model (LLM) to perform a first task type associated with a first task type using a first prompt comprising a task reasoning and an instruction associated with the task. The task reasoning comprises a set of guidelines associated with the task. The embodiments describe executing the LLM to perform the first task type. Performing the first task type comprises the LLM generating an output using the set of guidelines associated with the task. The embodiments describe executing the LLM to perform a second task type associated with the task using a second prompt. The second prompt comprises the instruction associated with the task. Performing the second task type comprises the LLM generating the output using the set of guidelines associated with the task

### TECHNICAL FIELD

Embodiments of the invention relate to the technical fields of fine-tuning domain-specific large language models.

### BACKGROUND

Large language models can include billions of parameters that allow large language models to perform natural language processing tasks. Training large language models requires significant computing resources and training data.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for training a machine learning model using a training manager of a computing system, in accordance with some embodiments of the present disclosure.

FIG. 2 is an example of a prompt used to train a machine learning model to perform a domain-specific task, in accordance with some embodiments of the present disclosure.

FIG. 3 is a flow diagram of an example method for fine-tuning a machine learning model, in accordance with some embodiments of the present disclosure.

FIG. 4 is a flow diagram of an example method for deploying a machine learning model during inference, in accordance with some embodiments of the present disclosure.

FIG. 5 is an example of a prompt used during inference of a fine-tuned machine learning model to perform a domain-specific task, in accordance with some embodiments of the present disclosure.

FIG. 6 is an example of a dependency network, in accordance with some embodiments of the present disclosure.

FIG. 7 is a flow diagram of an example method of deploying multiple adaptation components in a multi-headed fine-tuned machine learning model, in accordance with some embodiments of the present disclosure.

FIG. 8 is a block diagram of a computing system that includes a training manager, in accordance with some embodiments of the present disclosure.

FIG. 9 is an example of an entity graph in accordance with some embodiments of the present disclosure.

FIG. 10 is a flow diagram of an example method for training a large language model using reasoning distillation, in accordance with some embodiments of the present disclosure.

FIG. 11 is a block diagram of an example computer system including a training manager, in accordance with some embodiments of the present disclosure.

### DETAILED DESCRIPTION

Generative models use artificial intelligence technology, e.g., neural networks, to machine-generate new digital content based on model inputs and the previously existing data with which the model has been trained. Whereas discriminative models are based on conditional probabilities P(y|x), that is, the probability of an output y given an input x (e.g., is this a photo of a dog?), generative models capture joint probabilities P(x, y), that is, the likelihood of x and y occurring together (e.g., given this photo of a dog and an unknown person, what is the likelihood that the person is the dog's owner, Sam?). A generative language model is a particular type of generative model that generates new text in response to model input. A large language model (LLM) is a type of generative language model that is trained using an abundance of data (e.g., publicly available data) such that billions of parameters that define the LLM are used to iteratively develop statistical correlations that enable the performance of a task.

LLMs are trained to perform tasks by relying on patterns and inferences learned from training data, without requiring explicit instructions to perform the tasks. For example, LLMs predict a next token of a block of text. In operation, LLMs track relationships in sequential data by receiving tokens (e.g., words in a sentence) and predicting a next token (or sequence of tokens). As such, LLMs are able to mimic human language by generating responses that are coherent and contextualized. These models are well suited to perform different tasks by predicting tokens (or sequences of tokens) such as form conversations (e.g., taking turns asking questions and providing responses), summarize information, classify data, or extract information.

Fine-tuning, as used herein may refer to a mechanism of adjusting the parameters of the machine learning model that has been previously trained (e.g., pretrained) by training the pretrained machine learning model to perform a new or different task. For example, a machine learning model trained to perform text summarization using domain-neutral data (e.g., publicly available data) can be fine-tuned to perform domain-specific text summarization using domain-specific data (e.g., data specific to a particular entity or technology field which may not be publicly available). Domain-specific data, unlike domain-neutral data, may include domain-specific vocabulary, domain-specific style (e.g., acronyms, tones), and/or domain-specific formatting. For example, a resume (e.g., a type of document used in professional connections settings) can include a particular formatting (e.g., bullet points, headings, spacing), style (e.g., professional tone, lack of acronyms), and/or vocabulary that is different from the formatting, style, and/or vocabulary of a domain-neutral document such as an article that is publicly available. The characteristics of domain-specific data distinguish such data from domain-neutral data that may not have the same vocabulary, style preferences, and/or formatting preferences. As such, the statistical correlations iteratively developed by a machine learning model pretrained to perform text summarization (or a different task) using domain-neutral data are insufficient if the machine learning model is used to perform text summarization using domain-specific data. That is, the machine learning model pretrained to perform text summarization using domain-neutral data may perform text summarization using domain-specific data at a degree of confidence that fails a threshold degree of confidence.

Supervised learning is a method of training (or fine-tuning) a machine learning model, such as an LLM, given input-output pairs. An input-output pair is an input with an associated known output (e.g., an expected output, a labeled output, a ground truth). During a training period, a machine learning model iteratively develops statistical correlations used to perform a task, such as a natural language processing (NLP) task, by receiving training samples included as a training input. The machine learning model then predicts an output, by identifying one or more values with the highest confidence scores or probabilities, related to the task to be learned. The predicted output is then compared to the known output associated with the training input (e.g., the output of the input-output pair). Over time, (e.g., a number of training iterations), an error based on the difference between the predicted output and the known output decreases.

In some conventional systems, multiple machine learning models are each trained to perform a different domain-specific task. For example, in some conventional systems, a first machine learning model is trained to perform a task such as extract a content type from domain-specific content items. For instance, the conventional first machine learning model extracts job titles of users from a resume. In the same example, a second machine learning model is trained to perform a second task such as classify entities in domain-specific content items. For example, the conventional second machine learning model classifies user skills, user information, company information, and the like from resumes. Embodiments of the technologies described herein can avoid the need to deploy multiple separately trained models by using a single machine learning model that has been trained to perform multiple domain-specific tasks. In this manner, computing resources associated with deploying multiple machine learning models are reduced. For example, instead of deploying two machine learning models, as in the above-described example of a conventional system, embodiments deploy a single machine learning model.

In some conventional systems, a single machine learning model is trained to perform multiple tasks. For example, when the tasks are related, machine learning models can beneficially share features, layers, weights, or other parameters, improving the efficiency and accuracy of performing multiple target tasks using a single machine learning model. The training data used to train the machine learning model to perform previous tasks can be mixed with the training data used to train the machine learning model to perform new tasks. However, training a machine learning model to perform multiple tasks can result in catastrophic forgetting, in which the machine learning model “forgets” previously learned tasks as the machine learning model learns new tasks. When the machine learning model forgets previously learned tasks, the statistical correlations developed to capture relationships among the data associated with the previously learned task are adapted to capture relationships among the data associated with the new task. The modification of the statistical correlations associated with training the machine learning model to perform a new task distinct from a task already learned by the machine learning model will improve the machine learning model's capability to perform the new task, but reduce the machine learning model's capability to perform the previously learned task. That is, the previously learned task is performed at a degree of confidence or reliability less than a threshold degree of confidence or reliability.

The input to a LLM (both a training input or an input used during deployment of the LLM) includes a task description, also referred to as a prompt. A prompt can be in the form of natural language text, such as a question or a statement, and can include non-text forms of content, such as digital imagery and/or digital audio. The prompt can include instructions and/or examples of content used to explain the task that the LLM is to perform. Modifying the instructions, examples, content, and/or structure of the prompt causes modifications to the output of the LLM. For example, changing the instructions included in the prompt causes changes to the generated content determined by the LLM.

Prompt engineering is a technique used to optimize the structure and/or content of the prompt input to the LLM. Some prompts can include examples of outputs to be generated by the LLM (e.g., few-shot prompts), while other prompts can include no examples of outputs to be generated by the LLM (e.g., zero-shot prompts). Chain of thought prompting is a prompt engineering technique where the prompt includes a request that the LLM explain reasoning in the output. For example, the LLM performs the task provided in the prompt using intermediate steps where the LLM explains the reasoning as to why it is performing each step.

Crafting the prompts used by the LLM can be technically challenging. For example, determining what information to include the in prompt and how to convey the information in the prompt is directly related to how the LLM performs the target task. In particular, if too much information is included in the prompt, the instructions in the prompt can become diluted, causing the LLM to perform the target task with reduced accuracy. For instance, if a prompt includes instructions that define a particular output format, among other instructions, the LLM may perform the target task but not generate the output using the particular output format defined in the prompt.

The technologies described herein train a machine learning model to perform a set of domain-specific tasks while mitigating catastrophic forgetting. Mitigating catastrophic forgetting means that the machine learning model can perform multiple tasks at an accuracy or confidence value that satisfies a threshold degree of confidence or reliability. Training the machine learning model while mitigating catastrophic forgetting includes distilling reasoning associated with performing a set of tasks. Distilling reasoning associated with performing a set of tasks enables the machine learning model to generalize the performance of the set of tasks. As described above, conventional prompt engineering techniques are focused on crafting a particular prompt to optimize the performance of the machine learning model in performing a particular task. That is, conventional prompts can instruct the machine learning model of the steps associated with performing the task. In contrast, training or fine-tuning a machine learning model using reasoning distillation causes the machine learning model to evaluate or perform intermediate steps associated with performing a task (e.g., teach the machine learning model how to perform the task). Distilling reasoning during training or fine-tuning the machine learning model enables the machine learning model to develop statistical correlations associated with how the machine learning model approaches the performance of a set of tasks instead of teaching the machine learning model to perform each task of the set of tasks. In other words, reasoning traces are learned by the domain-specific machine learning model such that the machine learning model develops statistical correlations associated with performing each domain-specific task of the domain-specific set of tasks.

A single machine learning model trained to perform multiple domain-specific tasks (e.g., the fine-tuned machine learning described herein) is more efficient than multiple machine learning models each trained to perform a domain-specific task. For instance, computing resources such as power, memory, and bandwidth are conserved by reducing the number of machine learning models trained, stored in memory, or deployed. Additionally, a single machine learning model that is generalized to perform multiple domain-specific task types associated with a domain-specific task (using reasoning distillation, for instance) is more efficient than multiple machine learning models each trained to perform a domain-specific task type. As described herein, the fine-tuned machine learning model generalizes performing a domain-specific task using reasoning distillation such that the training data associated with developing the statistical correlations to perform the domain-specific task types associated with the task is reduced. That is, the machine learning model is efficiently trained to perform multiple domain-specific task types associated with a domain-specific task such that the number of input-output pairs (e.g., training data) is reduced, thereby reducing computing resources associated with generating input-output pairs. For example, training data used to train the machine learning model to perform a domain-specific task can be used to develop statistical correlations to perform a set of domain-specific task types associated with the domain-specific task, thereby reducing the training data associated with developing statistical correlations used to perform each domain-specific task type in the set of domain-specific task types.

Additionally, a machine learning model, trained using reasoning distillation to perform a set of tasks can be leveraged to perform task chains. For example, the machine learning model can perform multiple tasks (e.g., a first task and a second task) in a task chain of two tasks. The reasoning distillation enables the machine learning model to perform multiple tasks without causing the machine learning model to forget previously learned tasks.

Certain aspects of the disclosed technologies are described in the context of generative models that output pieces of writing, i.e., natural language text. However, the disclosed technologies are not limited to uses in connection with text output. For example, aspects of the disclosed technologies can be used to generate outputs that include non-text forms of machine-generated output, such as digital imagery, videos, and/or audio.

The disclosure will be understood more fully from the detailed description given below, which references the accompanying drawings. The detailed description of the drawings is for explanation and understanding and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains but can be used with or incorporated into other embodiments, including embodiments shown in other drawings.

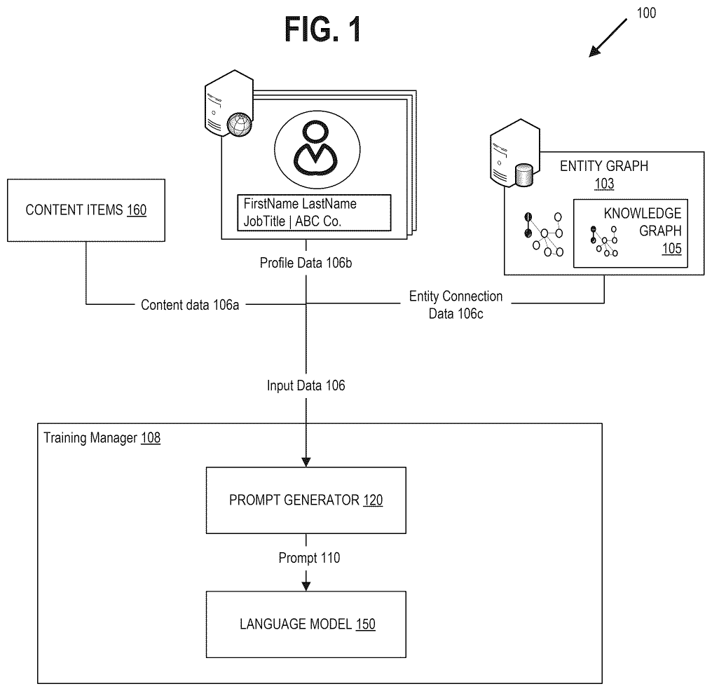

FIG. 1 is a flow diagram of an example method for training a machine learning model using a training manager of a computing system, in accordance with some embodiments of the present disclosure.

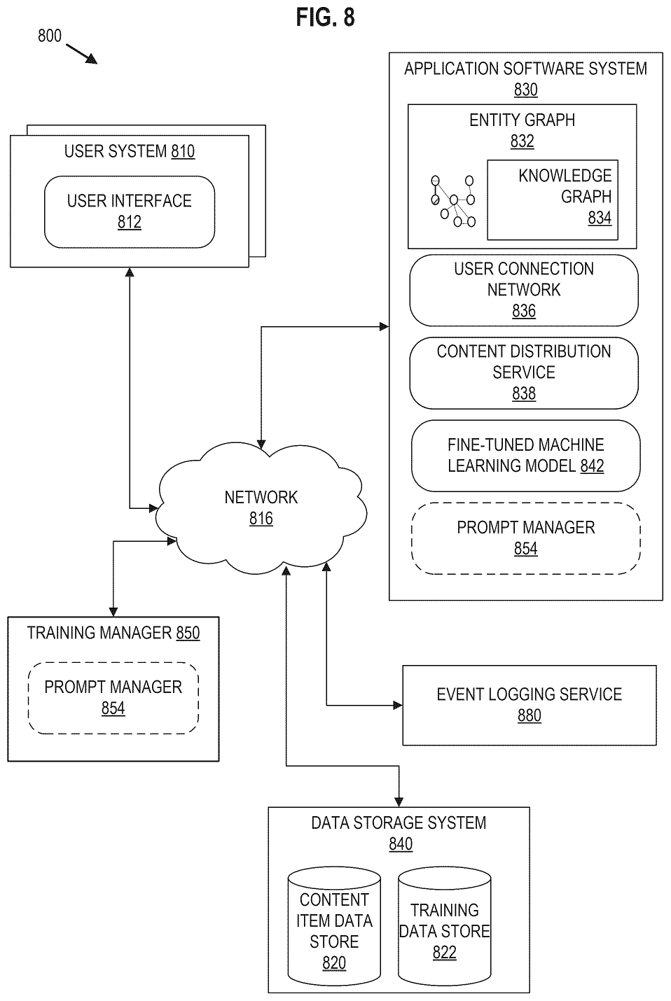

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of an application software system 830 of FIG. 8 or the training manager 850 of FIG. 8, including, in some embodiments, components shown in FIG. 8 that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, computing system 100 includes a training manager 108. The training manager 108 of FIG. 1 includes a prompt generator 120 and a language model 150. As described herein, the training manager 108 uses the prompt generator 120 to train the language model 150 to perform multiple domain-specific tasks, each domain-specific task associated with multiple domain-specific task types. A task type is a particular task based on a type of input. Each domain-specific task is associated with a set of domain-specific task types based on the types of input documents used to perform the task. For example, given a first task of summarization and the type of input document being a resume, a first task type associated with the first task is summarizing the resume. Given the first task of summarization and the type of input document being a job post, a second task type associated with the first task is summarizing the job post. Further, given a second task of classification and the type of input document being a user profile, the first task type associated with the second task is classifying entities in the user profile. In the example of FIG. 1, the components of the training manager 108 are implemented using an application server or server cluster, which can include a secure environment (e.g., secure enclave, encryption system, etc.) for the processing of input data 106.

As indicated in FIG. 1, components of computing system 100 are distributed across multiple different computing devices, e.g., one or more client devices, application servers, web servers, and/or database servers, connected via a network, in some implementations. In other implementations, at least some of the components of computing system 100 are implemented on a single computing device such as a client device.

The input data 106 can include content data 106a, profile data 106b, and entity connection data 106c. The input data 106 can be provided to the training manager 108 from a variety of different data sources including user interfaces, databases and other types of data stores, including online, real-time, and/or offline data sources. In some embodiments, content data 106a is received via one or more user devices or systems, such as portable user devices like smartphones, wearable devices, tablet computers, or laptops; profile data 106b is received via one or more web servers; and entity connection data 106c is received via one or more database servers; however, any of the different types of input data 106 can be received by the training manager 108 via any type of electronic machine, device or system.

Content items 160 include any digital content that can be displayed to a user. Content data 106a is the content items passed to the training manager 108 as part of input data 106. For example, content data 106a can include articles, job posting, blogs, user profiles, etc. In some embodiments, content items 160 include unstructured data. Unstructured data includes files stored without metadata or a predetermined format such as free-form text (e.g., one or more words, phrases, or sentences). In some embodiments, content items 160 include structured data. Structured data is data in a predetermined format (e.g., JSON format, bullet points). In some embodiments, before content items 160 are used as input data 106, user permission is obtained. For example, an author of a content item 160 consents to using content item 160 as input data 106.

Profile data 106b can include any information associated with a user. Examples of profile data 106b include user experience, interests, areas of expertise, educational history, job titles, skills, job history, etc. Profile data 106b can be obtained by the training manager 108 by, for example, querying one or more data stores that store entity profile data. In some embodiments, before profile data is used as input data 106, user permission is obtained.

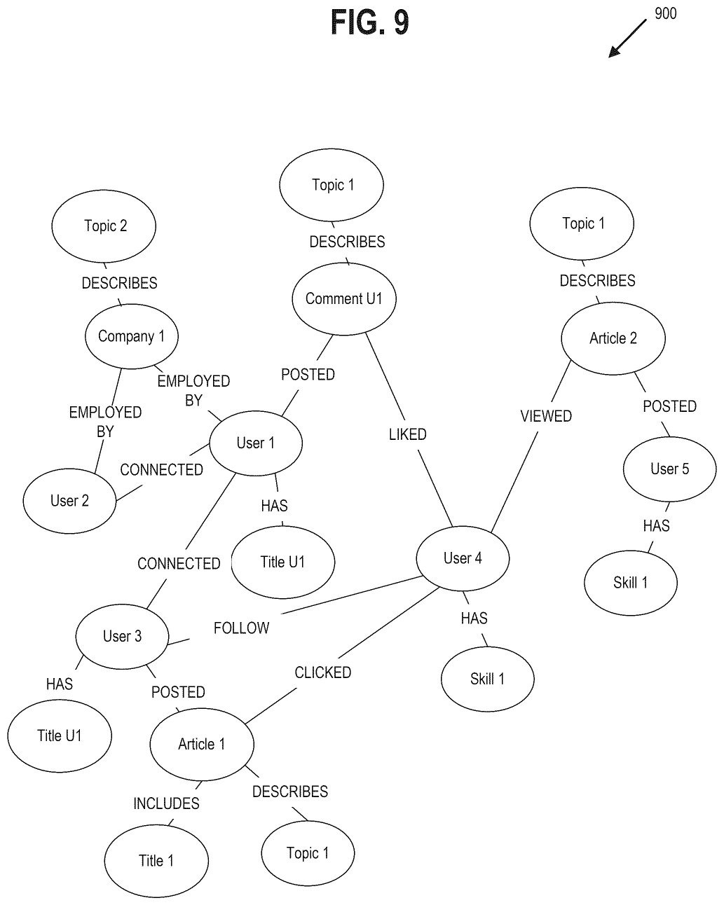

Entity connection data 106c includes data and a relationship of data to other data. Examples of entity connection data 106c include data extracted from entity graph 103 and/or knowledge graph 105. The entity graph 103 includes entity profile data arranged according to a connection graph, e.g., a graph of connections and relationships between users of a user connection network and between users and other entities. For example, the entity graph 103 represents entities as nodes and relationships between entities as edges between the nodes. In some implementations, entity graph 103 includes a cross-application knowledge graph 105. The cross-application knowledge graph 105 is a subset of the entity graph 103 or a superset of the entity graph 103 (e.g., a combination of multiple entity graphs) that links data from the user connection network with data from other application software systems, such as a user connection network or a search engine. Entity connection data 106c is extracted from an application software system operating the entity graph 103 or knowledge graph 105 by, for example, traversing the entity graph 103 or knowledge graph 105, e.g., by executing one or more queries on one or more data stores that store data associated with the nodes and edges of the entity graph 103 or knowledge graph 105. An example of an entity graph or cross-application knowledge graph is shown in FIG. 9, described herein.

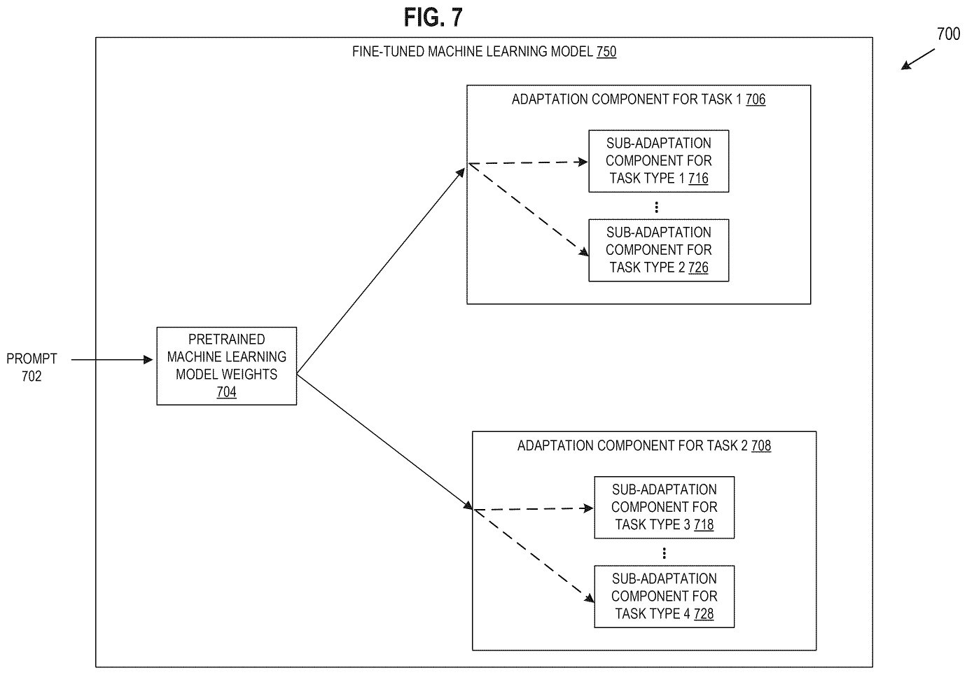

The prompt generator 120 receives the input data 106 and generates prompt 110 for the language model 150. The prompt 110 is used to train the language model 150 to perform a domain-specific task, which is associated with a set of domain-specific task types. For example, a first prompt 110 is used to train the language model 150 to perform a first task (e.g., a summarization task). Reasoning traces are developed during fine-tuning such that the language model 150 can perform multiple domain-specific task types associated with the first domain-specific task, where the domain-specific task types are dependent on the type of input document. For example, a first domain-specific task type associated with a domain-specific task is summarize a user profile, a second domain-specific task type associated with the domain-specific task is summarize a job post, and a third domain-specific task type associated with the domain-specific task is summarize a resume. In other words, the language model 150 iteratively develops statistical correlations during a training period that enables the language model 150 to perform domain-specific task types associated with the domain-specific task within a threshold degree of confidence. For example, the language model 150 iteratively develops statistical correlations during the training period that enables the language model 150 to perform tasks and task-types within a threshold degree of confidence determined for a professional connections network or other professional setting. The statistical correlations that enable the language model 150 to perform the domain-specific task are generalized such that the language model 150 can perform the set of domain-specific task types associated with a domain-specific task, as described in FIG. 7. That is, the language model 150 can perform domain-specific task types associated with a domain-specific task without being trained to perform the domain-specific task types. In some embodiments, a second prompt 110 is used to train the language model 150 to perform a second task (e.g., a classification task). The reasoning traces developed during fine-tuning enable the language model 150 to perform multiple task types associated with the second task (e.g., classify entities in a job post, classify entities in a resume, etc.).

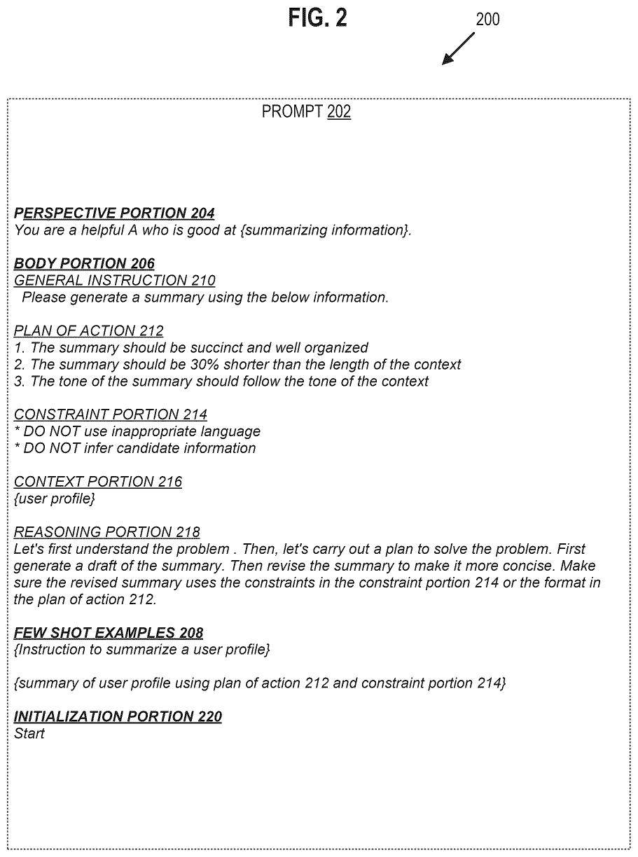

In some embodiments, the prompt generator 120 generates one or more portions of the prompt 110 by applying one or more string transformations to the input data 106. For example, received content data 106a can be inserted into a prompt by creating an input prompt string. An example prompt used to train the language model 150 is described in FIG. 2.

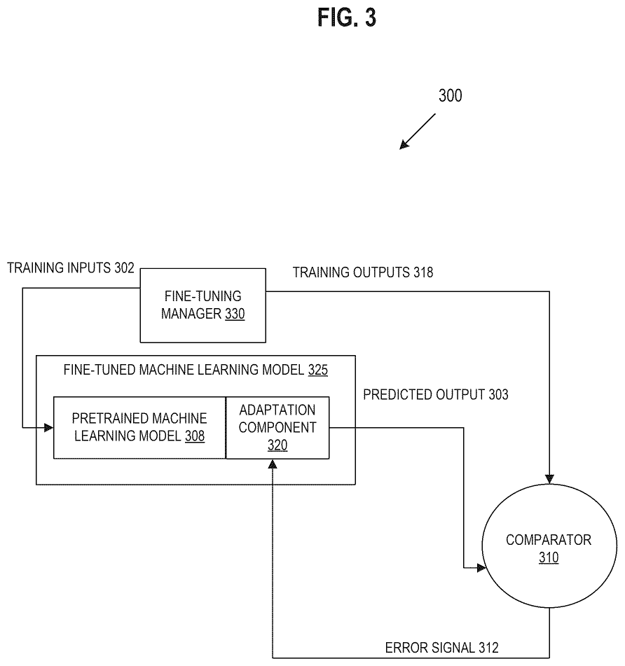

The language model 150 is a pretrained machine learning model that has been pretrained to perform general tasks using-domain neutral data. In some embodiments, language model 150 is a generative pretrained transformer (GPT) machine learning model. As described with reference to FIG. 3 below, the language model 150 is fine-tuned such that the language model can perform tasks and associated task types (e.g., a set of task types), where both the tasks and the associated task types are domain-specific.

In some embodiments, the language model 150 is a multi-headed machine learning model. A multi-headed machine learning model is a single machine learning model that is trained to perform multiple tasks. That is, the prompt 110 used to train the language model 150 to perform a domain-specific task (e.g., summarization) enables the language model 150 to iteratively develop statistical correlations that enable the language model 150 to identify complex patterns encoded in domain-specific data (in addition to, or instead of, the complex patterns encoded in the domain-neutral data) associated with multiple domain-specific task types (e.g., summarizing a resume, summarizing a user profile, summarizing a job post) associated with the domain-specific task. In some embodiments, each head of the multi-headed machine learning model performs a domain-specific task type associated with a target domain-specific task. For example, a first head is configured to summarize a resume, a second head is configured to summarize a user profile, and a third head is configured to summarize a job post. In some embodiments, each head of the multi-headed machine learning model performs a domain-specific target task. For example, a first head is configured to perform summarization tasks, a second head is configured to perform classification tasks, and a third head is configured to perform question-and-answer tasks. An example of the multi-headed machine learning model is described in FIG. 7.

The examples shown in FIG. 1 and the accompanying description above are provided for illustration purposes. This disclosure is not limited to the described examples. Additional or alternative details and implementations are described herein.

FIG. 2 is an example of a prompt used to train a machine learning model to perform a domain-specific task, in accordance with some embodiments of the present disclosure.

As described herein, a prompt instructs a language model such as a LLM to perform a task. Example 200 illustrates a portion of prompt 202 passed to language model 150 by the prompt generator 120 during training, described in FIG. 1. The prompt 202 instructs the machine learning model how to perform a domain-specific task (e.g., a summarization task, a classification task, an entity extraction task, etc.) by instructing the machine learning model what to do and how to do it using the body portion 206 described herein. However, during fine-tuning described in FIG. 3, the prompt 202 enables the machine learning model to generalize the way in which it performs the target task. Accordingly, the machine learning model iteratively develops statistical correlations that enable the machine learning model to perform domain-specific task types associated with the domain-specific target task. That is, given a target task and/or a first task type (e.g., the target task associated with a first type of input such as a user profile), the machine learning model can perform a set of domain-specific task types. As shown, the target task is a summarization task. Accordingly, the machine learning model can learn to perform a summarization task of a user profile, a resume, a job post, an article, or other types of domain-specific input documents.

While training the machine learning model with respect to a target task using prompt 202 is illustrated in example 200, it should be appreciated that the machine learning model can be trained to perform task types using a prompt. For example, in some embodiments, the prompt can instruct a machine learning model how to perform a domain-specific task type (e.g., summarization of a resume) associated with a target task (e.g., summarization). During fine-tuning, the prompt enables the machine learning model to generalize the way in which it performs the task type. As a result, the machine learning model iteratively develops statistical correlations that enable the machine learning model to perform a second domain-specific task type (e.g., summarization of a job post) associated with the target task (e.g., summarization).

The predetermined portions of prompt 202 (e.g., portions 204-220) are specific enough to instruct the machine learning model how to perform the summarization task, but are general enough to enable the machine learning model to generalize different types of summarization tasks that are dependent on the type of domain-specific input document (e.g., task types). For example, using prompt 202, the machine learning model can iteratively develop statistical correlations that enable the machine learning model to summarize a user profile, summarize an article, or summarize a job posting, for instance. In operation, the machine learning model can be trained to perform a first domain-specific task associated with a first domain-specific task type using prompt 202, not be trained to perform a second domain-specific task type associated with the first domain-specific task, yet still perform the second domain-specific task type associated with the first domain-specific task.

The prompt 202 of example 200 includes four portions. The first portion (e.g., perspective portion 204) is a portion that defines the perspective of the language model. For example, the perspective portion 204 states that the language model is “A” with a task of performing “B.” As shown, the task to be performed by the machine learning model is a summarization task, however other tasks (or task types) can be included in the perspective portion (e.g., classification task, entity extraction task, question-and-answer task). In some embodiments, there is a different prompt associated with each task.

The second portion (e.g., body portion 206) is the main body of the prompt 202. The body portion 206 instructs the machine learning model of the domain-specific task to be performed (e.g., a general idea of what to generate and how to generate it). The body portion 206 of the prompt 202 includes multiple sub-portions 210-218 that define logic such as domain-specific business logic or domain-specific formatting logic. For example, the general instruction 210 and context portion 216 include business logic that enable the machine learning model to perform a domain-specific task. The plan of action 212 and the constraint portion 214 include formatting logic that defines the output of the domain-specific task to be performed. In prompt 202, the task to be performed is a summarization task and the formatting logic defines the length of the summary, language to use or not use in the summary, and the tone of the summary.

The body portion 206 includes a general instruction 210. In some embodiments, the general instruction portion 210 instructs the machine learning model of the task to be performed. As shown, the general instruction 210 portion indicates that the language model is to generate a summary. In some embodiments, the general instruction 210 reiterates the goal of the machine learning model described in the perspective portion 204.

The plan of action 212 portion of the body portion 206 instructs the machine learning model how to perform a domain-specific task (e.g., generate the summary). For example, the plan of action 212 defines a set of guidelines that the machine learning model is instructed to use when generating the summary (or otherwise performing the domain-specific task). In some embodiments, the instructions in the plan of action 212 are predetermined. For example, the instructions in the plan of action 212 define that the summary should be limited to 300 characters. In other embodiments (as shown), the instructions in the plan of action 212 are based on the content of the input document. For example, as shown, the machine learning model is instructed to generate a summary that is “30% shorter than the length of the content,” which is defined in context portion 216. In some embodiments, the instructions included in the plan of action 212 portion are sequential, indicating an order in which the machine learning model is to perform the steps in the prompt 202. In some embodiments, the instructions are ordered. For example, a natural language instruction includes words such as “first” and “second” to indicate an order of instructions.

The constraint portion 214 of the body portion 206 includes a collection of domain-specific requirements that restrict the content generated by the language model when performing the domain-specific task (e.g., the summarization task defined in the general instruction 210). In some embodiments, the constraints in the constraint portion 214 are predetermined. In some embodiments, the constraints in the constraint portion 214 are based on the context portion 216.

The context portion 216 of the body portion 206 includes contextual information that the language model can use when performing the target task. In some embodiments, the context portion 216 includes a reference to a document (such as a URL, a document identifier, etc.) and/or content of the document to be used by the language model. In some embodiments, the context is a domain-specific digital content item (e.g., content items 160 described in FIG. 1). For example, given the domain of an online system for jobs or job candidates over a professional social network that includes information about companies, job postings, and users of the online system, the context can include domain-specific inputs such as a job post, a resume, a blog, a user profile, a comment, an article, or an email.

The reasoning portion 218 reinforces the body portion 206 by instructing the language model to generate an approach to solving the task to be performed using the information in the prompt 202 (e.g., a reasoning). In other words, the reasoning portion 218 is a reminder of the information in the body portion 206. In some embodiments, the reasoning portion 218 is a constrained plan of action (cPoA). The constrained plan of action defined in the reasoning portion 218 can be included in the prompt 202 used to train the machine learning model when a target task is subjective (e.g., summarization tasks, question-and-answer tasks). In some embodiments, the reasoning portion 218 is chain of thought instruction, which instructs the machine learning model to perform a target task using intermediary steps. The chain of thought instructions defined in the reasoning portion 218 can be included in the prompt 202 used to train the machine learning model when a target task is objective (e.g., classification tasks, entity extraction tasks).

In prompt 202, the reasoning portion 218 is an example of cPoA reasoning. As shown, the reasoning portion 218 instructs the machine learning model to write the summary content and subsequently revise the generated summary. The machine learning model is reminded to check that the generated summary satisfies any constraints in the constraint portion 214 or format instructions defined in the plan of action 212. In some embodiments, the reasoning portion 218 is not included in the prompt 202.

The third portion (e.g., few-shot examples 208) includes an example of an instruction to perform a domain-specific target task type (e.g., generate a summary of a user profile) and a corresponding domain-specific output (e.g., the summary of the user profile using the plan of action 212 and the constraint portion 214). While one example is show in the few-shot example 208 portion, other examples can be included in the few-shot example 208 portion (e.g., other instructions to perform a target task type and corresponding outputs). In some embodiments, the few-shot example 208 portion is not included in prompt 202.

The fourth portion (e.g., initialization portion 220) initializes the task to be performed. For example, the machine learning model summarizes a user profile identified in the context portion 216 according to the plan of action 212 and the constraint portion 214, using the reasoning portion 218.

FIG. 3 is a flow diagram of an example method for fine-tuning a machine learning model, in accordance with some embodiments of the present disclosure.

While example 300 illustrates fine-tuning a pretrained machine learning model 308 with respect to one or more domain-specific target tasks, it should be appreciated that the same method can be used to fine-tune the pretrained machine learning model 308 with respect to one or more domain-specific task types associated with a domain-specific target task.

The pretrained machine learning model 308 can be any sequence-to-sequence machine learning model. For example, the pretrained machine learning model 308 can include an instance of a text-based encoder-decoder model that accepts a string as an input and outputs a string. The pretrained machine learning model 308 is trained on domain-neutral data (e.g., publicly available data) to perform one or more domain-neutral tasks. The pretrained machine learning model 308 can be pretrained using any training method such as supervised learning, unsupervised learning, semi-supervised learning, reinforcement learning, etc.

A layer may refer to a sub-structure of the pretrained machine learning model 308 that includes a number of nodes (e.g., neurons) that perform a particular computation and are interconnected to nodes of adjacent layers. Nodes in each of the layers sum up values from adjacent nodes and apply an activation function, allowing the layers to detect nonlinear patterns. Nodes are interconnected by weights, which are adjusted based on an error during a training phase. The adjustment of the weights during training enables the pretrained machine learning model 308 to perform the domain-neutral tasks (e.g., text extraction, text summarization, classification) with a certain degree of confidence or reliability. At the completion of training, the pretrained machine learning model 308 includes a set of pretrained weights in a pretrained weight matrix trained to perform one or more domain-neutral tasks using domain-neutral data.

The pretrained machine learning model 308 includes one or more self-attention layers (including the pretrained weight matrix) that are used to attend (e.g., assign weight values) to portions of the model input. Alternatively, or in addition, the pretrained machine learning model 308 includes one or more feed-forward layers (including the pretrained weight matrix) and residual connections that allow the pretrained machine learning model 308 to encode or decode complex data patterns including relationships between different portions of the model input in multiple different contexts.

Fine-tuning the pretrained machine learning model 308 allows the pretrained machine learning model 308, which has a general natural language understanding, to perform domain-specific tasks. The fine-tuning manager 330 fine-tunes an adaptation component 320 using domain-specific data which causes the fine-tuned machine learning model 325 to iteratively develop statistical correlations that enable the fine-tuned machine learning model 325 to perform one or more domain-specific tasks. The adaptation component 320 can include one or more weight matrices appended to one or more weight matrices in the pretrained machine learning model 308 and/or one or more layers appended to one or more layers of the pretrained machine learning model 308. The fine-tuned (or trained) adaptation component 320 together with the pretrained machine learning model 308 results in the fine-tuned machine learning model 325. Fine-tuning the pretrained machine learning model 308 is fine-tuning (or training) the adaptation component 320 without changing the domain-neutral pretrained weights of the pretrained weight matrix. While fine-tuning an adaptation component is described, the same techniques and principles can be applied to fine-tuning a sub-adaptation component. Adaptation components and sub-adaptation components are described in FIG. 7.

As described herein, supervised learning is a method of training a machine learning model given input-output pairs. The input-output pair is training data used to train the adaptation component 320 to perform a domain-specific task. While one adaptation component 320 is shown, it should be appreciated that multiple adaptation components 320 can be appended to layers and/or weights of the pretrained machine learning model 308.

In some embodiments, a first adaptation component 320 is trained (or fine-tuned) to perform a first downstream task such as a classification task using classification-specific input-output pairs. The input of the classification-specific input-output pair, represented as training inputs 302, includes the training document (e.g., domain-specific training content) and a taxonomy. The training document can be a reference to a document (such as a URL, a document identifier, etc.) and/or content of the document. The training document is a domain-specific digital content item (e.g., content items 160 described in FIG. 1). For example, given the domain of an online system for jobs or job candidates over a professional social network that includes information about companies, job postings, and users of the online system, the training document can include a job post, a resume, a blog, a user profile, a comment, an article, or an email. The taxonomy can include one or more labels associated with the attributes to be classified. For example, labels associated with a “certification type” attribute associated with a job post in the trucking industry can include “driver's license,” or “class B license” for instance. In some embodiments, the taxonomy includes definitions associated with each label. In some embodiments, the taxonomy includes aliases associated with each label. In some embodiments, the taxonomy is included as part of the body portion 206 of prompt 202 and the training document is included as part of the context portion 216 described in FIG. 2.

The output of the classification-specific input-output pair, represented as training output 318, is used to train the adaptation component 320 to perform the classification task. The training output 318 can be a classification of text of the training document. For example, the output 318 can be a classified attribute. In a non-limiting example, for a training document that is a resume, the classified attribute can include “technical skills,” “education,” “work history,” or “hobbies.” The classified attributes are dependent on the content of the training document. For example, some resumes include a “hobby” portion. Additionally, the classified attributes are dependent on the training document. For example, attributes mentioned in a training document if the training document is a job post can include “work culture,” “industry experience,” and “technical skills” for instance. However, such attributes may not be present in a training document if the training document is an article, for instance.

As a result of training the first adaptation component 320 using the training data (e.g., the classification-specific input-output pairs), the adaptation component 320 iteratively develops statistical correlations that enable the fine-tuned machine learning model 325 to perform domain-specific classification tasks. In addition, training (or fine-tuning) the pretrained machine learning model 308 using the prompt described in FIG. 2 and the classification-specific input-output pairs enables the fine-tuned machine learning model 325 to become generalized such that the fine-tuned machine learning model 325 can perform a set of domain-specific classification task types associated with classification tasks using a set of adaptation components 320. For example, the fine-tuned machine learning model 325 can perform classification of a first domain-specific task type (e.g., classifying attributes in a job posting using a first sub-adaptation component) and classification of a second domain-specific task type (e.g., classifying attributes in a resume using a second sub-adaptation component), where the first domain-specific task type and the second domain-specific task type are associated with a domain-specific task (e.g., a classification task associated with a first adaptation component). Adaptation components and sub-adaptation components are described in FIG. 7. In operation, the fine-tuned machine learning model 325 develops statistical correlations associated with a diverse set of domain-specific vocabulary (e.g., defined according to the taxonomy), which increases the encoded domain-specific vocabulary and enables the fine-tuned machine learning model 325 to perform robust classification of attributes in a diverse set of domain-specific documents (e.g., resumes, job posts, articles).

In some embodiments, a second adaptation component 320 is trained (or fine-tuned) to perform a second downstream task such as entity extraction using entity extraction-specific input-output pairs. The input of the entity extraction-specific input-output pairs, represented as training inputs 302, includes the training document (e.g., domain-specific training content) and a list of possible entity types. The list of possible entity types includes a list of entities that are associated with the content of the training document. In some embodiments, the list of entities includes a definition of each entity and/or provides aliases for each of the entities associated with the content of the training document. In some embodiments, the list of entities is included as part of the body portion 206 of prompt 202 and the training document is included as part of the context portion 216 described in FIG. 2.

The output of the entity extraction-specific input-output pairs, represented as training output 318, is used to train the adaptation component 320 to perform the extraction task. The training output 318 can be values included in the training document that are related to entities in the list of possible entities. For example, the adaptation component 320 identifies a value of the training document corresponding to the extracted entity type. The values are string matches of one or more words from the training document. Accordingly the output is a pair of one or more entities and corresponding values extracted from the training document as an entity-value pair.

As a result of training the second adaptation component 320 using the training data (e.g., the entity extraction-specific input-output pairs), the adaptation component 320 iteratively develops statistical correlations that enable the fine-tuned machine learning model 325 to perform domain-specific entity extraction tasks. In addition, training (or fine-tuning) the pretrained machine learning model 308 using the prompt described in FIG. 2 and the entity extraction-specific input-output pairs enables the fine-tuned machine learning model 325 to become generalized such that the fine-tuned machine learning model 325 can perform domain-specific entity extraction task types associated with domain-specific entity extraction tasks using a set of adaptation components 320 (e.g., sub-adaptation components). For example, the fine-tuned machine learning model 325 can perform entity extraction of a first domain-specific task type (e.g., extracting entity-value pairs in a job posting using a first sub-adaptation component) and entity extraction of a second domain-specific task type (e.g., extracting entity-value pairs in a resume using a second sub-adaptation component), where the first domain-specific task type and the second domain-specific task type are associated with a domain-specific task (e.g., an entity extraction task associated with the second adaptation component). Adaptation components and sub-adaptation components are described in FIG. 7. In operation, the entity extraction-specific input-output pairs enable the fine-tuned machine learning model 325 to perform robust entity extraction capabilities. Unlike conventional named entity recognition (NER) tagging, the fine-tuned machine learning model 325 can extract arbitrary domain-specific entities from a training document. The diverse range of entity types received as part of the training input 302 increases the domain-specific vocabulary encoded by the adaptation component 320. As a result of training the second adaptation component 320 using the training data (e.g., the entity extraction specific input-output pairs), the adaptation component 320 iteratively develops statistical correlations that enable the fine-tuned machine learning model 325 to perform domain-specific entity extraction tasks.

In some embodiments, a third adaptation component 320 is trained (or fine-tuned) to perform a third downstream task such as a question-and-answer task using question and answer-specific input-output pairs. The input of the question and answer-specific input-output pairs, represented as training inputs 302, includes the training document (e.g., domain-specific training content) and questions. The questions can be a list of one or more questions associated with the training document. In some embodiments, the questions are included as part of the body portion 206 of prompt 202 and the training document is included as part of the context portion 216 described in FIG. 2. The output of the question and answer-specific input-output pairs, represented as training output 318, is used to train the adaptation component 320 to perform the question-and-answer task. The training output 318 can be domain-specific answers to domain-specific questions about the training document. The answers respond to each of the questions in the list of questions. In some embodiments, the answers mirror the same style (e.g., vocabulary, formality, tone) as the style of the training document (e.g., vocabulary, formality, tone).

As a result of training the third adaptation component 320 using the training data (e.g., the question and answer-specific input-output pairs), the adaptation component 320 iteratively develops statistical correlations that enable the fine-tuned machine learning model 325 to perform domain-specific question-and-answer tasks. In addition, training (or fine-tuning) the pretrained machine learning model 308 using the prompt described in FIG. 2 and the question and answer-specific input-output pairs enables the fine-tuned machine learning model 325 to become generalized such that the fine-tuned machine learning model 325 can perform a set of question and answer task types associated with question and answer tasks using a set of adaptation components 320 (e.g., sub-adaptation components). Adaptation components and sub-adaptation components are described in FIG. 7. Accordingly, the fine-tuned machine learning model 325 is generalized such that the fine-tuned machine learning model 325 can perform question-and-answer task types associated with domain-specific question-and-answer tasks. For example, the fine-tuned machine learning model 325 can answer questions of a first domain-specific task type (e.g., questions associated with a job posting) and answer questions of a second domain-specific task type (e.g., questions associated with a resume), where the first domain-specific task type and the second domain-specific task type are associated with a domain-specific task (e.g., a question-and-answer task). In operation, the question and answer-specific input-output pairs enable the fine-tuned machine learning model 325 to iteratively develop statistical correlations that support critical reasoning for questions associated with a diverse set of documents (e.g., resumes, job posts, articles).

In some embodiments, a fourth adaptation component 320 is trained (or fine-tuned) to perform a fourth downstream task such as text summarization using summarization-specific input-output pairs. The input of the summarization-specific input-output pairs, represented as training inputs 302, include the training document (e.g., domain-specific training content) and, in some embodiments, summary guidelines. The summary guidelines can include summary instructions with respect to summary length, summary format, summary style (e.g., language style), summary structural composition, and summary content focus (e.g., specific guidelines on what to include and what to avoid). In some embodiments, the summary guidelines are based on the training document. For example, based on the training document being a half a page in length, the summary guidelines suggest that the summary should be 2-3 sentences. In another non-limiting example, based on the training document being divided into Section A, Section B, and Section C, the summary guidelines suggest that the summary should similarly have a Section A, Section B, and Section C structure. FIG. 2 describes the summary guidelines included as part of the body portion 206 of prompt 202 and the training document (e.g., a user profile) included as part of the context portion 216.

The output of the summarization-specific input-output pairs, represented as training output 318, is used to train the adaptation component 320 to perform the text summarization task. The training output can be a text summary of the training document. The text summary is a summary of the content of the training document using the summary guidelines. Accordingly, the text summary is constrained, based on the summary guidelines, with respect to summary length, summary format, summary style, and/or summary content focus.

As a result of training the fourth adaptation component 320 using the training data (e.g., the summarization-specific input-output pairs), the adaptation component 320 iteratively develops statistical correlations that enable the fine-tuned machine learning model 325 to perform domain-specific text summarization tasks. In addition, training (or fine-tuning) the pretrained machine learning model 308 using the prompt described in FIG. 2 and the summarization-specific input-output pairs enables the fine-tuned machine learning model 325 to become generalized such that the fine-tuned machine learning model 325 can perform domain-specific summarization task types associated with domain-specific summarization tasks using a set of adaptation components 320. For example, the fine-tuned machine learning model 325 can perform summarization of a first domain-specific task type (e.g., summarizing a job posting using a first sub-adaptation component) and summarizing of a second domain-specific task type (e.g., summarizing a resume using a second sub-adaptation component), where the first domain-specific task type and the second domain-specific task type are associated with a domain-specific task (e.g., a summarization task associated with the fourth adaptation component). Adaptation components and sub-adaptation components are described in FIG. 7. In operation, the summarization-specific input-output pairs and the training prompt enable the fine-tuned machine learning model 325 to follow diverse summarization instructions (e.g., summary guidelines) that improve the fine-tuned machine learning model 325 ability to produce tailored summaries for a diverse set of documents (e.g., resumes, job posts, articles).

In some embodiments, the machine learning model 325 can be fine-tuned using task type specific input-output pairs. The task type specific input-output pairs are dependent on a task to be performed (e.g., summarization, classification, entity extraction, question-and-answer) and the domain-specific training document (e.g., a resume, a job post, an article). For example, the input of a job post classification input-output pair (e.g., an input of a first task type specific input-output pair), represented as training input 302, includes a job post training document (e.g., domain-specific training content) and a specific job post taxonomy. The output of the job post classification input-output pair (e.g., an output of the first task type specific input-output pair), represented as training output 318, is a classification of text of the job post. As described herein, the fine-tuned machine learning model 325 is generalized such that the fine-tuned machine learning model 325 can perform the job post classification task (e.g., the first task type) and a resume classification task (e.g., a second task type) given the first task type and the second task type are associated with a target task (e.g., a classification task).

The fine-tuning manager 330 fine-tunes one or more adaptation components 320 using the domain-specific task-specific input-output pairs described above (e.g., classification-specific input-output pairs, entity extraction-specific input-output pairs, question and answer-specific input-output pairs, and summarization-specific input-output pairs) or domain-specific task type specific input-output pairs. In some embodiments, the adaptation component 320 is initialized with the weights of the pretrained machine learning model 308. In some embodiments, the adaptation component 320 is initialized with a low-rank pair of matrices that represent the interconnections between non-redundant neurons in the pretrained machine learning model (e.g., Low-Rank Adaptation of weights). In some embodiments, the adaptation component 320 is initialized with random weight values.

Supervised learning is a method of training (or fine-tuning) the weight values of a machine learning model (e.g., the pretrained machine learning model 308 or the adaptation component 320) given input-output pairs. In some embodiments, the fine-tuning manager 330 fine-tunes the weights in the pretrained machine learning model 308. For example, the value of the pretrained weights in the pretrained weight matrix is adjusted according to an error (e.g., the error 312 determined by the comparator 310 comparing the training output 318 to the predicted output 303). In other embodiments, the pretrained weight matrix of the pretrained machine learning model 308 is stored and the weights of the adaptation component 320 are trained (e.g., updated). While supervised learning is described, other training methods including semi-supervised learning or federated learning can be used to fine-tune the pretrained machine learning model 308 and/or adaptation component 320.

A domain-specific task-specific input of the domain-specific task-specific input-output pairs (e.g., represented generally as training input 302) is provided to the pretrained machine learning model 308 using a prompt such as prompt 202 described in FIG. 2 by the fine-tuning manager 330. The pretrained machine learning model and the adaptation component 320 then determine predicted output 303 by applying the weights and nodes of the pretrained machine learning model 308 and the weights and/or nodes of the adaptation component 320 to the training input 302.

The predicted output 303 is the domain-specific task specific predicted output associated with the domain-specific task specific input. The error (represented by the error signal 312) is determined by comparing the predicted output 303 to the training output 318 using the comparator 310. In operation, given a training input 302 of the classification-specific input-output pairs (e.g., training document, attributes to classify, and a taxonomy included in a prompt), the predicted output 303 is a classification, which is compared to the training output 318 classification. Given a training input 302 of the entity extraction-specific input-output pairs (e.g., training document and a list of possible entity types included in a prompt), the predicted output 303 is one or more values included in the training document that are related to entities in the list of possible entities (e.g., entity-value pairs) and the training output 318 includes entity-value pairs. Given a training input 302 of the question and answer-specific input-output pairs (e.g., a training document and question included in the prompt), the predicted output 303 is an answer and the training output 318 is an answer. Given a training input 302 of the summarization-specific input-output pairs (e.g., training document and summary guidelines included in the prompt), the predicted output 303 is a summary of the training document in accordance with the summary guidelines and the training output 318 is a summary of the training document in accordance with the summary guidelines. In some embodiments, the predicted output 303 can include reasoning (e.g., a list of steps performed by the pretrained machine learning model 308 to arrive at the predicted output 303).

In some embodiments, the comparator 310 evaluates the similarity between the predicted output 303 to the training output 318 using any similarity metric. For example, the comparator 310 can compare the similarity of the text strings of a predicted output 303 to the text strings of the training output 318 using the Recall-Oriented Understudy for Gisting Evaluation (ROUGE) score.

The error signal 312 is used to adjust the adaptation component 320 (e.g., the value of weights in a weight matrix included in the adaptation component 320 and/or the number of layers and/or arrangement of layers included in the adaptation component 320). The adjustment of the adaptation component 320 during training enables the fine-tuned machine learning model 325 to iteratively develop statistical correlations used to perform the domain-specific task associated with the input-output pair.

The adaptation component 320 and/or pretrained machine learning model 308 may be trained using a backpropagation algorithm, for instance. The backpropagation algorithm operates by propagating the error signal 312 through each of the algorithmic weights of the adaptation component 320 and/or pretrained machine learning model 308 such that the algorithmic weights adapt based on the amount of error. The error signal 312 may be calculated at each iteration (e.g., each input-output pair), batch, and/or epoch. After a set of training iterations, the fine-tuned machine learning model 325 iteratively converges, e.g., changes over time to generate an acceptably accurate (e.g., accuracy satisfies a defined tolerance or confidence level) predicted output 303 using the training input 302 and the training output 318. The value of the weights is stored such that the fine-tuned machine learning model 325 can be deployed during inference time.

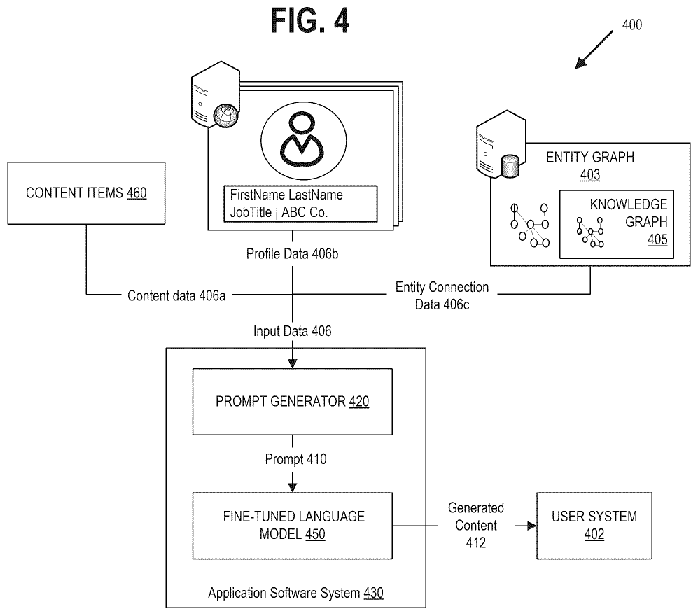

FIG. 4 is a flow diagram of an example method for deploying a machine learning model during inference, in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of an application software system 830 of FIG. 8, including, in some embodiments, components shown in FIG. 8 that may not be specifically shown in FIG. 4. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

Components of computing system 400 are distributed across multiple different computing devices, e.g., one or more client devices, application servers, web servers, and/or database servers, connected via a network, in some implementations. In other implementations, at least some of the components of computing system 400 are implemented on a single computing device such as a client device.

Input data 406 can be similar to input data 106 described in FIG. 1. For example, similar to content item 160 described in FIG. 1, content items 460 can include any digital content that can be displayed to a user. Content data 406a is the content items passed to the prompt generator 420 as part of input data 106. Similar to profile data 106b described in FIG. 1, profile data 406b can include any information associated with a user. Similar to entity connection data 106c described in FIG. 1, entity connection data 406c includes data and a relationship of data to other data. Examples of entity connection data 406c include data extracted from entity graph 403 and/or knowledge graph 405.

User system 402 includes at least one computing device, such as a personal computing device, a server, a mobile computing device, or a smart appliance. User system 402 includes at least one software application, enabling the user system 402 to bidirectionally communicate with the application software system 430.

Application software system 430 is any type of application software system that provides or enables at least one form of digital content distribution of content items 460 and/or generated content 412 to user systems such as user system 402. Examples of application software system 430 include but are not limited to connections network software, such as social media platforms, and systems that are or are not based on connections network software, such as general-purpose search engines, job search software, recruiter search software, sales assistance software, content distribution software, learning and education software, or any combination of any of the foregoing.

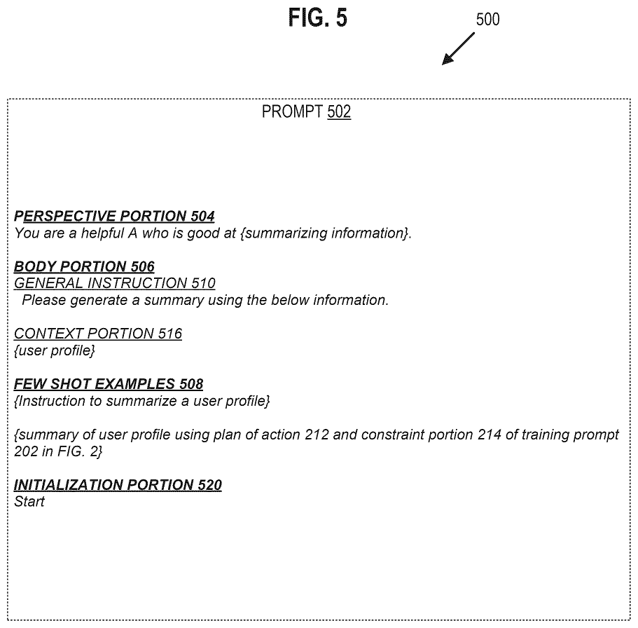

The prompt generator 420 receives the input data 406 and generates prompt 410 for the fine-tuned language model 450. Prompt 410 is a simplified prompt including fewer instructions or lines of code than prompt 110 described in FIG. 1. An example of prompt 410 is described in FIG. 5. In some embodiments, prompt 410 can include additional information not present in prompt 110 described in FIG. 1 (e.g., additional input data 406).

The fine-tuned language model 450 receives prompt 410 and performs the domain-specific target task and/or a domain-specific task type associated with the domain-specific target task defined in prompt 410. The fine-tuned language model 450 can be a large language model fine-tuned, as described in FIG. 3. As a result of the fine-tuning, the fine-tuned language model 450 is generalized and can perform a set of domain-specific task types associated with a domain-specific task. For example, after training the fine-tuned language model 450 to perform a domain-specific task such as summarization using domain-specific data, the fine-tuned language model 450 is generalized such that it can perform domain-specific task types associated with the domain specific summarization task such as summarize a job posting, summarize an article, summarize a resume, or summarize a user profile.

The fine-tuned language model 450 performs the domain-specific task included in prompt 410 to generate content 412. The generated content 412 is passed to the user system 402 for display to a user and/or subsequent processing. The generated content 412 is dependent on the domain-specific task. For example, given a classification task, the generated content 412 includes assigning labels from a given taxonomy to a document based on the content in the domain-specific document. A taxonomy is a list of labels which may be associated with a definition and/or one or more aliases and included in prompt 410 (e.g., received as additional input data 406 from the user system 402) or encoded by the fine-tuned language model 450 during fine-tuning. An alias is a synonym or other semantically similar word or phrase associated with the label. After performing the classification task, the fine-tuned language model 450 identifies one or more attributes to be classified. For example, attributes mentioned in a resume, can include “technical skills,” “education,” “work history,” or “hobbies.” The attributes identified by the fine-tuned language model 450 are dependent on the content of the resume. For example, some resumes include a “hobby” portion, while others do not. Additionally, the attributes identified by the fine-tuned language model 450 are dependent on the domain-specific input document. For example, attributes mentioned in a job post can include “work culture,” “industry experience,” and “technical skills” for instance. However, such attributes may not be present in an article, for instance.

Given an entity extraction task, the generated content 412 includes identifying and extracting specific entities from an input domain-specific document. Specifically, the fine-tuned language model 450 identifies values from the input document that correspond to an entity. The values are string matches of one or more words from the document. The entities identified from the document can include words or phrases included in prompt 410 (e.g., received as additional input data 406 from the user system 402) or encoded by the fine-tuned machine learning model 450 during fine-tuning. Accordingly, the entities extracted by the fine-tuned language model 450 are dependent on the content of the document.

Given a question-and-answer task, the generated content 412 includes generated answers to a list of questions. The list of questions can be included in the prompt 410 (e.g., received as additional input data 406 from the user system 402) or encoded by the fine-tuned language model 450 during fine-tuning. The questions can be about the content of the domain-specific document, subject matter related to the content of the domain-specific document, subject matter inferred from the content of the domain-specific document, or the like. In some embodiments, the generated answers can mirror the same style (e.g., vocabulary, formality, tone) as the style of the uploaded document (e.g., vocabulary, formality, tone).

Given a summarization task, the generated content 412 is summarized text. In some embodiments, text summarization task is more than generating concise version of text. For example, the summarization task includes generating a summary of text according to a set of domain-specific requirements such as summary length, summary format, summary style (e.g., language style), summary structural composition, and summary content focus (e.g., specific guidelines on what to include and what to avoid). In a non-limiting example, based on the document length of half a page, the summary guidelines suggest that the summary should be 2-3 sentences. In another non-limiting example, based on the document being divided into Section A, Section B, and Section C, the summary guidelines suggest that the summary should similarly have a Section A, Section B, and Section C structure. The summary guidelines are included in the prompt 410 (e.g., received as additional input data 406 from the user system 402) or encoded by the fine-tuned language model 450 during fine-tuning.

FIG. 5 is an example of a prompt used during inference of a fine-tuned machine learning model to perform a domain-specific task, in accordance with some embodiments of the present disclosure.

Example 500 illustrates a portion of prompt 502 passed to an LLM (such as fine-tuned language model 450 described in FIG. 4) by a prompt generator during inference. The prompt 502 explicitly instructs a machine learning model to perform a task (e.g., a summarization task, a classification task, an entity extraction task, etc.). Because of the fine-tuning described in FIG. 3, the fine-tuned machine learning model is able to generalize a set of domain-specific task types associated with the domain-specific task. That is, the fine-tuned machine learning model can perform a set of domain-specific task types based on training the machine learning model using a prompt (such as prompt 202 described in FIG. 2) associated with a domain-specific task.

As shown, the instructions in the prompt 502 are smaller than the instructions provided to the machine learning model during fine-tuning. That is, there are fewer instructions in prompt 502 than prompt 202 described in FIG. 2, for instance. Although there are fewer instructions in prompt 502 than prompt 202 described in FIG. 2, the fine-tuned machine learning model is not only able to perform a target task as if the fine-tuned machine learning model had all of the instructions available in prompt 202, but the fine-tuned machine learning model is also able to perform task types associated with the target task as if the machine learning model had all of the instructions available in prompt 202.

The distillation of reasoning during fine-tuning using prompt 202 for instance, reduces the size of the prompt needed during deployment (e.g., prompt 502). Reducing the size of the prompt can increase the accuracy of the fine-tuned machine learning model in performing a task. For example, the instructions provided to the fine-tuned machine learning model to perform a target task are clear and concise, enabling the fine-tuned machine learning model to perform the target task at an accuracy that satisfies a threshold confidence or reliability. Having a prompt with clear and concise instructions enables a machine learning model to follow the instructions in the prompt accurately. For example, given a long and complex prompt including multiple sets of instructions, the machine learning model may inadvertently follow some instructions and/or rules and skip or “forget” to follow other instructions and/or rules of the prompt. Accordingly, having clear and concise constructions enables the machine learning model to perform a target task accurately (e.g., at a degree of confidence or reliability that meets of exceeds a threshold). Further, reducing the size of the prompt allows for increased supplemental

information to be included in the prompt. For example, user information can be included in the prompt, increasing the accuracy of the fine-tuned machine learning model in performing a task related to a user associated with the user information. Further, prompt 502 can include additional context information in the context portion 516 described below. Additionally or alternatively, prompt 502 can include additional few-shot examples in few-shot example 508 described below.

Additionally, reducing the size of the prompt needed during deployment (e.g., prompt 502) using reasoning distillation during fine-tuning (using prompt 202 for instance), reduces the computing resources, power, and/or bandwidth associated with deploying the fine-tuned LLM. For example, reducing the size of the prompt reduces the computing resources, power, and/or bandwidth consumed by the fine-tuned LLM to process the prompt and perform the tasks defined in the prompt.

The perspective portion 504 can be similar to the perspective portion 204 described in FIG. 2. For example, the perspective portion 504 can define the perspective of the fine-tuned machine learning model. The body portion 506 can be similar to the body portion 206 described in FIG. 2 with fewer instructions. For example, there is no plan of action portion 212 or constraint portion 214 (described in FIG. 2) in prompt 502 of FIG. 5. That is, prompt 502 can be similar to prompt 202 with the exception of formatting information because the fine-tuned machine learning model has developed statistical correlations that encode the formatting information in the output generated by the fine-tuned machine learning model (e.g., the task to be performed). In other words, although prompt 502 is missing plan of action portion 212 and constraint portion 214 described in FIG. 2, the fine-tuned machine learning model is able to perform the domain-specific task and/or domain-specific task type as if the fine-tuned machine learning model had the plan of action portion 212 and constraint portion 214 described in FIG. 2. As a result, the output of the fine-tuned machine learning model given prompt 502 would be similar to the output of the machine learning model given prompt 202. In some embodiments, the general instruction 510 is similar to the general instruction 210 described in FIG. 2. For example, the general instruction 210 instructs the machine learning model of the task to be performed. In some embodiments, the context portion 516 is similar to the context portion 216 described in FIG. 2. For example, the context portion 516 includes contextual information (such as a reference to a document using a URL or other document identifier) to be used by the fine-tuned machine learning model when performing the target task. In some embodiments, the few-shot example portion 508 is similar to the few-shot example portion 208 described in FIG. 2. In some embodiments, the few-shot example portion 508 is not included in prompt 502. In some embodiments, the initialization portion 520 is similar to the initialization portion 220 described in FIG. 2. For example, the initialization portion 220 initializes the task to be performed.

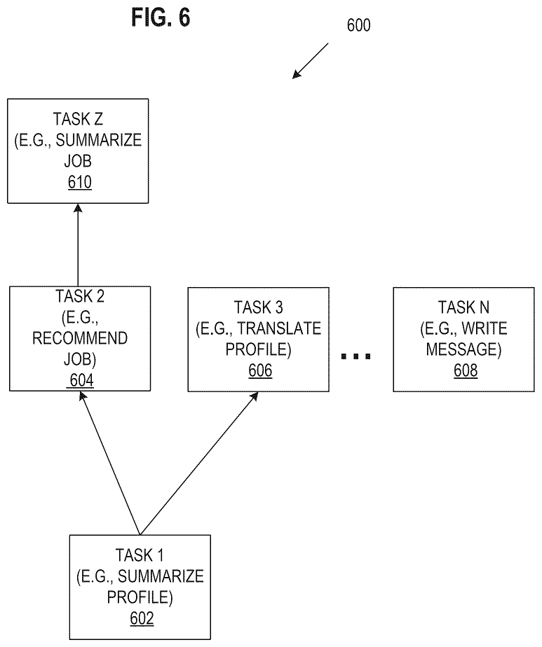

FIG. 6 is an example of a dependency network, in accordance with some embodiments of the present disclosure.

Each task (e.g., task 1 . . . task Z) in the dependency network 600 represent tasks performed by a machine learning model. Some tasks in the dependency network 600 can be dependent on other tasks (e.g., a sequence of tasks). For example, as shown in dependency network 600, arrows connecting tasks represent tasks in a task chain. In a first task chain, task Z 610 depends on task 2 604 and task 1 602. In other words, the summarize job position task (e.g., task Z 610) is performed using the output of task 2 604 (e.g., a job position recommendation) as an input. That is, a job position is summarized based on a recommended job position. The job position recommendation (e.g., output of task 2 604) is performed using the output of task 1 602 (e.g., a summary of a user profile) as an input. That is, a job position is recommended based on a summary of a user profile. As another example of a sequence of tasks in a task chain, a translate profile task (e.g., task 3 606) is performed using the output of task 1 602 (e.g., a summary of a user profile) as an input. That is, a user profile is translated based on a summary of a user profile. In some embodiments, other tasks in the dependency network 600 are not dependent on subsequent tasks. For example, the task associated with writing a message (e.g., task N 608) does not depend on other tasks.

Because the output of the machine learning model is relied upon to perform subsequent tasks in a task chain at a threshold degree of confidence or reliability, the machine learning model cannot “forget” how to perform tasks in a task chain. That is, while fine-tuning the machine learning model to perform task 2 604, the statistical correlations determined while training the machine learning model to perform task 1 602 cannot be modified in such a way that decreases the performance of task 1 602. If the statistical correlations associated with the parameters used to perform task 1 are modified during training of task 2, then the machine learning model will perform task 1 with reduced accuracy (e.g., an accuracy that is less than a threshold degree of confidence or reliability). As a result of performing task 1 with reduced accuracy, then the performance of task 2, which is dependent on the task 1, can be performed with reduced accuracy.

Accordingly, the machine learning model fine-tuned to perform subsequent tasks in a task chain (e.g., task 2 or task 3 that depends on task 1) is fine-tuned using prompts such as prompt 202 described in FIG. 2, which enables the machine learning model to learn the reasoning associated with how to perform tasks instead of learning to perform tasks. As described herein, each task learned by the machine learning model is trained using a modified prompt with a task-specific perspective portion (e.g., perspective portion 204), a task-specific general instruction (e.g., general instruction 210), a task-specific plan of action (e.g., plan of action 212), a task-specific constraint (e.g., constraint portion 214), a task-specific reasoning (e.g., reasoning portion 218), and in some instances, one or more task-specific few-shot examples (e.g., few-shot examples 208) described in FIG. 2. As a result of the fine-tuning, the machine learning model can perform multiple tasks in a task chain (e.g., task 1 602, task 2 604, and task Z 610), each task performed with an accuracy or confidence that satisfies a threshold degree of confidence or reliability. In some embodiments, different confidence thresholds are associated with different tasks.

FIG. 7 is a flow diagram of an example method of deploying multiple adaptation components in a multi-headed fine-tuned machine learning model, in accordance with some embodiments of the present disclosure.

Each adaptation component represents the ability of the fine-tuned machine learning model 750 to perform a domain-specific task. For example, adaptation component 706 enables the fine-tuned machine learning model 750 to perform task 1 and adaptation component 708 enables the fine-tuned machine learning model 750 to perform task 2. Using multiple adaptation components allows the fine-tuned machine learning model 750 to perform multiple domain-specific tasks including classification, entity extraction, question-and-answer, and summarization, while mitigating catastrophic forgetting.

While the fine-tuned machine learning model 750 is shown with adaptation components in parallel (e.g., both adaptation component for task 1 706 and adaptation component for task 2 708 receive the output from the pretrained machine learning model weights 704), in some embodiments, adaptation components are cascading. For example, the output from adaptation component for task 1 706 is used as an input for the adaptation component for task 2 708.

As described herein, each domain-specific task (e.g., task 1 and task 2) can be associated with a set of domain-specific task types, where the task type is based on the type of input document. In some embodiments, each domain-specific task type associated with a domain-specific task is performed using a sub-adaptation component. For example, task 1 (represented using adaptation component 706) is associated with sub-adaptation component for task type 1 716 (e.g., performing a classification task using a resume as an input) and sub-adaptation component for task type 2 726 (e.g., performing a classification task using a user profile as an input). Similarly, task 2 (represented using adaptation component 708) is associated with sub-adaptation component for task type 3 718 (e.g., performing a summarization task using an article as an input) and sub-adaptation component for task type 4 728 (e.g., performing a summarization task using a user profile as an input).

The sub-adaptation components within an adaptation component (e.g., sub-adaptation component for task type 1 716 and sub-adaptation component for task type 2 726 associated with adaptation component for task 1 706 and sub-adaptation component for task type 3 718 and sub-adaptation component for task type 4 728 associated with adaptation component for task 2 708) are activated responsive to an indication or instruction in prompt 702. For example, given an instruction in prompt 702 to perform task 1 using a specific type of input document (e.g., a resume), the sub-adaptation component for task type 1 corresponding to the type of input document receives the output of the pretrained machine learning model weights 704. In some embodiments, any sub-adaptation component associated with an adaptation component is activated (e.g., receives the output of the pretrained machine learning model weights 704) and an output determined by a sub-adaptation component that satisfies an output threshold is selected as the output of the fine-tuned machine learning model 750.

In some embodiments, the adaptation component for each domain-specific task can perform the operations of each sub-adaptation component associated with the domain-specific task. For example, adaptation component for task 1 706 can perform the operations of both the sub-adaptation component for task type 1 716 and sub-adaptation component for task type 2 726.

As described herein, the machine learning model generalizes performance of domain-specific task types associated with a domain-specific task. That is, because the machine learning model is fine-tuned using reasoning traces, statistical correlations are developed that enable the fine-tuned machine learning model 750 to perform domain-specific task types associated with a domain-specific task using an approach (instead of perform tasks or task types using explicit instructions). In other words, fine-tuning the machine learning model to perform task type 1 (e.g., by fine-tuning sub-adaptation component for task type 1 716) can be generalized such that the fine-tuned machine learning model 750 can perform task type 2 (e.g., using sub-adaptation component for task type 2 726). In operation, the loss determined during fine-tuning, as described in FIG. 3 above, can be weighted and applied to each sub-adaptation component of an adaptation component. As a result, the loss determined during a single training iteration can be weighted and backpropagated to each sub-adaptation component of an adaptation component such that the sub-adaptation components are modified together. Accordingly, each sub-adaptation component iteratively develops statistical correlations associated with performing a task, but each sub-adaptation component can become specialized to perform the task associated with a particular type of input document. For instance, if sub-adaptation component for task type 1 716 is to perform task 1 for a particular task type (e.g., a resume), then the sub-adaptation component for task type 1 716 can be backpropagated with a larger loss value (e.g., a large percentage of loss) than sub-adaptation component for task type 2 726 (or other sub-adaptation components associated with adaptation component for task 1 706) given the input document used during a training iteration is a resume. Similarly, if sub-adaptation component for task type 2 726 is to perform task 1 for a second task type (e.g., an article), then the sub-adaptation component for task type 2 726 can be backpropagated with a larger loss value (e.g., a large percentage of loss) than sub-adaptation component for task type 1 716 (or other sub-adaptation components associated with adaptation component for task 1 706) given the input document used during a training iteration is an article.

Prompt 702 is a prompt used during inference, such as prompt 502 described in FIG. 5. That is, prompt 702 may not include constraints or a plan of action as described in prompt 202 described in FIG. 2. Although prompt 702 may not include constraints or a plan of action, the output determined using the fine-tuned machine learning model 750 uses a set of guidelines, constraints, or the plan of action that was used to fine-tune the fine-tuned machine learning model 750. That is, statistical correlations encoding the set of guidelines, constraints, and/or the plan of action enables the fine-tuned machine learning model 750 to generate a constrained output as if the fine-tuned machine learning model 750 received a prompt constraining the output.

In operation, the pretrained machine learning model weights 704 are used to perform a task described in prompt 702. The output of the pretrained machine learning model weights 704 is a matrix of values determined using the pretrained machine learning model weights 704 applied to content included in the prompt 702. The matrix of values is passed to adaptation component for task 1 706 and/or adaptation component for task 2 708, which apply fine-tuned weight matrices using sub-adaptation component for task type 1 716 or sub-adaptation component for task type 2 of the adaptation component for task 1 706 or the sub-adaptation component for task type 3 718 or sub-adaptation component for task type 4 of the adaptation component for task type 2 708 respectively.

The ability of the fine-tuned machine learning model 750 to perform domain-specific task types is based on the matrices of values determined using each adaptation component (e.g., adaptation component for task 1 706 and adaptation component for task 2 708) and the pretrained machine learning model weights 704. For example, in some embodiments, the matrix of values determined from the pretrained machine learning model weights 704 is summed with (or otherwise applied to) a matrix of values determined from sub-adaptation component for task type 1 716, sub-adaptation component for task type 2 726, sub-adaptation component for task type 3 718, or sub-adaptation component for task type 4 728.

In some embodiments, the output from each of the adaptation component for task type 1 716, adaptation component for task type 2 726, adaptation component for task type 3 718, and adaptation component for task type 4 728 is a matrix of values representing a likelihood of a natural language word, token, or phrase being output by the fine-tuned machine learning model 650 in furtherance of the task described in prompt 702. In some embodiments, an adaptation component (and corresponding sub-adaptation components) are activated responsive to an indication or instruction in prompt 702. For example, given an instruction in prompt to perform task 1, the adaptation component for task 1 706 (and the corresponding sub-adaptation components) receive the output of the pretrained machine learning model weights 704. That is, instead of both adaptation component for task 1 706 and adaptation component for task 2 708 being activated for every input (and therefore receiving the output of the pretrained machine learning model weights 704), only the adaptation component associated with the task included in prompt 702 is activated (with the corresponding sub-adaptation components).

In some embodiments, the output of the fine-tuned machine learning model 750 is based on the likelihood of the natural language word, token, or phrase satisfying an output likelihood threshold. That is, each adaptation component is activated (e.g., receives the output of the pretrained machine learning model weights 704) and an output of a sub-adaptation component is selected based on the matrix of values representing the likelihood of a natural language word, token, or phrase satisfying the output likelihood threshold.

FIG. 8 is a block diagram of a computing system that includes a training manager, in accordance with some embodiments of the present disclosure.

In the embodiment of FIG. 8, a computing system 800 includes one or more user systems 810, a network 816, an application software system 830, a training manager 850, an event logging service 880, and a data storage system 840. All or at least some components of the fine-tuned machine learning model 842 are implemented at the user system 810, in some implementations. For example, the fine-tuned machine learning model 842 can be implemented directly upon a single client device and/or the application software system 830 without the need to communicate with, e.g., one or more servers over the Internet. Dashed lines are used in FIG. 8 to indicate that all or portions of the prompt manager 854 can be implemented directly at the application software system 830.

A user system 810 includes at least one computing device, such as a personal computing device, a server, a mobile computing device, or a smart appliance, and at least one software application that the at least one computing device is capable of executing, such as an operating system or a front end of an online system. Many different user systems 810 can be connected to network 816 at the same time or at different times. Different user systems 810 can contain similar components as described in connection with the illustrated user system 810. For example, many different end users of computing system 800 can be interacting with many different instances of application software system 830 through their respective user systems 810, at the same time or at different times.

User system 810 includes a user interface 812. User interface 812 is installed on or accessible to user system 810 by network 816. The user interface 812 can include, for example, a graphical display screen that includes graphical user interface elements such as at least one input box or other input mechanism and at least one slot. A slot as used herein refers to a space on a graphical display such as a web page or mobile device screen, into which natural language text can be entered by a user and/or user selections are received. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system.

In some implementations, user interface 812 enables the user to upload, download, receive, send, or share of other types of digital content items, including posts, articles, comments, and shares, to initiate user interface events, and to view or otherwise perceive output such as data and/or digital content produced by application software system 830 and/or content distribution service 838. For example, user interface 812 can include a graphical user interface (GUI), a conversational voice/speech interface, a virtual reality, augmented reality, or mixed reality interface, and/or a haptic interface. User interface 812 includes a mechanism for logging in to application software system 830, clicking or tapping on GUI user input control elements, and interacting with digital content. Examples of user interface 812 include web browsers, command line interfaces, and mobile app front ends. User interface 812 as used herein can include application programming interfaces (APIs).

In the example of FIG. 8, user interface 812 includes a front-end user interface component of application software system 830. For example, user interface 812 can be directly integrated with other components of any user interface of application software system 830. In some implementations, access to content of the application software system 830 is limited to registered users of application software system 830.

Network 816 includes an electronic communications network. Network 816 can be implemented on any medium or mechanism that provides for the exchange of digital data, signals, and/or instructions between the various components of computing system 800. Examples of network 816 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that provides or enables at least one form of digital content distribution of content items 160 to user systems such as user system 102. Examples of application software system 130 include but are not limited to connections network software, such as social media platforms, and systems that are or are not based on connections network software, such as general-purpose search engines, job search software, recruiter search software, sales assistance software, content distribution software, learning and education software, or any combination of any of the foregoing.

Application software system 830 includes any type of application software system that provides or enables the creation, upload, display, and/or distribution of at least one form of digital content, including user profiles, articles, comments, and videos between or among user systems, such as user system 810, through user interface 812. In some implementations, portions of the training manager 850 are components of application software system 830. Components of application software system 830 can include entity graph 832, knowledge graph 834, user connection network 836, content distribution service 838, and fine-tuned machine learning model 842.

In the example of FIG. 8, application software system 830 includes an entity graph 832 and/or a knowledge graph 834. Entity graph 832 and/or knowledge graph 834 include data organized according to graph-based data structures that can be traversed via queries and/or indexes to determine relationships between entities. An example of an entity graph is shown in FIG. 8, described herein. For example, as described in more detail with reference to FIG. 8, entity graph 832 and/or knowledge graph 834 can be used to compute various types of affinity scores, similarity measurements, and/or statistics between, among, or relating to entities.

Entity graph 832, 834 includes a graph-based representation of data stored in data storage system 8450, described herein. For example, entity graph 832, 834 represents entities, such as users, organizations, and content items, such as posts, articles, comments, and shares, as nodes of a graph. Entity graph 832, 834 represents relationships, also referred to as mappings or links, between or among entities as edges, or combinations of edges, between the nodes of the graph. In some implementations, mappings between different pieces of data used by application software system 830 are represented by one or more entity graphs. In some implementations, the edges, mappings, or links indicate online interactions or activities relating to the entities connected by the edges, mappings, or links. For example, if a first user views an article posted by a second user, an edge may be created connecting the first user and the article, where the edge may be tagged with a label such as “viewed.”

Portions of entity graph 832, 834 can be automatically re-generated or updated from time to time based on changes and updates to the stored data, e.g., updates to entity data and/or activity data. Also, entity graph 832, 834 can refer to an entire system-wide entity graph or to only a portion of a system-wide graph. For instance, entity graph 832, 834 can refer to a subset of a system-wide graph, where the subset pertains to a particular user or group of users of application software system 830.

In some implementations, knowledge graph 834 is a subset or a superset of entity graph 832. For example, in some implementations, knowledge graph 834 includes multiple different entity graphs 832 that are joined by edges. For instance, knowledge graph 834 can join entity graphs 832 that have been created across multiple different databases or across different software products. In some implementations, knowledge graph 834 includes a platform that extracts and stores different concepts that can be used to establish links between data across multiple different software applications. Examples of concepts include topics, industries, and skills.

Knowledge graph 834 includes a graph-based representation of data stored in data storage system 840, described herein. Knowledge graph 834 represents relationships, also referred to as links or mappings, between entities or concepts as edges, or combinations of edges, between the nodes of the graph. In some implementations, mappings between different pieces of data used by application software system 830 or across multiple different application software systems are represented by the knowledge graph 834.

User connection network 836 includes, for instance, a social network service, professional social network software and/or other social graph-based applications. Application software system 830 can include, for example, online systems that provide social network services, general-purpose search engines, specific-purpose search engines, messaging systems, content distribution platforms, e-commerce software, enterprise software, or any combination of any of the foregoing or other types of software.

A front-end portion of application software system 830 can operate in user system 810, for example as a plugin or widget in a graphical user interface of a web application, mobile software application, or as a web browser executing user interface 812. In an embodiment, a mobile app or a web browser of a user system 810 can transmit a network communication such as an HTTP (HyperText Transfer Protocol) request over network 816 in response to user input that is received through a user interface provided by the web application, mobile app, or web browser, such as user interface 812. A request is formulated, e.g., by a browser or mobile app at a user device, in connection with a user interface event such as uploading or storing a digital content item. The request includes, for example, a network message such as an HTTP request to store a digital content (e.g., a transfer of data from an application front end to the application's back end, or from the application's back end to the front end, or, more generally, a request for a transfer of data between two different devices or systems, such as data transfers between servers and user systems). A server running application software system 830 can receive the input from the web application, mobile app, or browser executing user interface 812, perform at least one operation using the input, and return output to the user interface 812 using a network communication such as an HTTP response, which the web application, mobile app, or browser receives and processes at the user system 810.

In the example of FIG. 8, application software system 830 includes a content distribution service 838. The content distribution service 838 can include a data storage service, such as a web server, which stores digital content items, uploaded by users, created by users, and/or searched for by users. Content distribution service 838 includes, for example, a chatbot or chat-style system, a messaging system, such as a peer-to-peer messaging system that enables the creation and exchange of messages among users of application software system 830, or a news feed. Such generated content can be stored in storage system 840 as content items of the content item data store 820. In some implementations, content distribution service 838 interfaces with application software system 830, for example, via one or more application programming interfaces (APIs).

In the example of FIG. 8, the training manager 850 includes a prompt manager 854. The prompt manager 854 is used to fine-tune or train a language model to become the fine-tuned machine learning model 842. The fine-tuned machine learning model 842 can perform multiple domain-specific tasks, where each task can be associated with multiple domain-specific task types (e.g., a set of task types). FIG. 2 illustrates an example prompt 202 generated by the prompt manager 854 that is used to train a machine learning model to perform a domain-specific task.

The prompt manager 854 is used to generate prompts that distill reasoning to the fine-tuned machine learning model 842 over the duration of the training period (e.g., a number of training iterations). During the training period, reasoning traces associated with performing the domain-specific task are learned by the fine-tuned machine learning model 842. In other words, the fine-tuned machine learning model 842 iteratively develops statistical correlations that enable the machine learning model 842 to perform the domain-specific task within a threshold degree of confidence. The statistical correlations that enable the machine learning model 842 to perform the domain-specific task are generalized such that the machine learning model 842 can perform task types associated with a domain-specific task. That is, the fine-tuned machine learning model 842 can be trained by the training manager 850 to perform a domain-specific task type associated with a domain-specific task (e.g., using a first prompt) and the fine-tuned machine learning model 842 can be executed to perform a domain-specific second task type associated with the domain-specific task (e.g., using a second prompt) without being trained to perform the second task type. The training manager 850 can be used to fine-tune adaptation components (or sub-adaptation components) using prompts generated by the prompt manager 854 such that the fine-tuned machine learning model 842 can perform various domain-specific tasks or domain-specific task types, as described with reference to FIG. 3 and FIG. 7. The adaptation component, together with a pretrained machine learning model, results in the fine-tuned machine learning model 842. The pretrained machine learning model can be any machine learning model pretrained to perform on or more tasks using domain-neutral data. In some embodiments, the pretrained machine learning model is any machine learning model such as a LLM.

Event logging service 880 captures and records network activity data generated during operation of application software system 830, including user interface events generated at user systems 810 via user interface 812, in real time, and formulates the user interface events into a data stream that can be consumed by, for example, a stream processing system. Examples of network activity data include clicks on messages or graphical user interface control elements, the creation, editing, sending, and viewing of messages, and social action data such as likes, shares, comments. For instance, when a user of application software system 830 via a user system 810 clicks on a user interface element, such as a message, a link, or a user interface control element such as a view, comment, share, or uploads a file, or creates a message, loads a web page, or scrolls through a feed, etc., event logging service 880 fires an event to capture an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile. For instance, when a user clicks on an article to view hosted on the application software system 830, event logging service 880 stores the corresponding event data in a log. Event logging service 880 generates a data stream that includes a record of real-time event data for each user interface event that has occurred.

Data storage system 840 includes data stores and/or data services that store digital data received, used, manipulated, and produced by application software system 830 and/or training manager 850, including a content item data store 820 and training data store 822.

The content item data store 820 stores digital content items hosted by the application software system 830, generated by the application software system 830, uploaded to the application software system 830, and the like. In some embodiments, digital content is tagged with privacy settings such that only users with one or more credentials have access to the tagged digital content. Content items stored in content item data store 820 can include job postings, comments, resumes, and articles. In some embodiments, content items include unstructured data. Unstructured data includes files stored without metadata or a predetermined format such as free-form text (e.g., one or more words, phrases, or sentences). In some embodiments, content items include structured data. Structured data is data in a predetermined format (e.g., JSON format, bullet points). In some embodiments, the content data store 820 includes other types of content such as profile data 106b described in FIG. 1 and/or entity connection data 106c described in FIG. 1.

The training data store 822 stores pairs of training data (e.g., input-output pairs) used to fine-tune the fine-tuned machine learning model 842. The training data store 822 can include sets of input-output pairs, where each set is associated with a task. For example, a first set of input-output pairs include classification-specific input-output pairs associated with a classification task, a second set of input-output pairs include entity extraction-specific input-output pairs associated with an entity-extraction task, a third set of input-output pairs include question and answer-specific input-output pairs associated with a question and answer task, and a fourth set of input-output pairs include summarization-specific input-output pairs associated with a summarization task. In some embodiments, each set of input-output pairs is associated with a task type. For example, a first set of input-output pairs is associated with a first task type (e.g., summarize a user profile), a second set of input-output pairs is associated with a second task type (e.g., summarize a resume), a third set of input-output pairs is associated with a third task type (e.g., summarize a job posting). In these embodiments, the first, second, and third set of input-output pairs are associated with a first task (e.g., a summarization task).

In some embodiments, the training data store 822 stores prompts used to fine-tune the fine-tuned machine learning model 842. The prompts used to fine-tuned the fine-tuned machine learning model 842 (e.g., prompts used during training) are described with reference to FIG. 2.

In some embodiments, the data storage system 840 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of the data storage system 840 can be configured to store data produced in real-time and/or offline (e.g., batch) data processing. Data stored in real time is data that is stored as soon as the data is received by the data storage system 840. A data store configured for real-time data processing can be referred to as a real-time data store. A data store configured for offline or batch data processing can be referred to as an offline data store. Data stores can be implemented using databases, such as key: value stores, relational databases, and/or graph databases. Data can be written to and read from data stores using query technologies, e.g., SQL or NoSQL.

A key: value database, or key: value store, is a nonrelational database that organizes and stores data records as key: value pairs. The key uniquely identifies the data record, i.e., the value associated with the key. The value associated with a given key can be, e.g., a single data value, a list of data values, or another key: value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

The data storage system 840 resides on at least one persistent and/or volatile storage device that can reside within the same local network as at least one other device of computing system 800 and/or in a network that is remote relative to at least one other device of computing system 800. Thus, although depicted as being included in computing system 800, portions of data storage system 840 can be part of computing system 800 or accessed by computing system 800 over a network, such as network 816.

While not specifically shown, it should be understood that any of user system 810, application software system 830, training manager 850, event logging service 880, and data storage system 840 includes an interface embodied as computer programming code stored in computer memory that when executed causes a computing device to enable bidirectional communication with any other of user system 810, application software system 830, training manager 850, event logging service 880, or data storage system 840 using a communicative coupling mechanism. Examples of communicative coupling mechanisms include network interfaces, inter-process communication (IPC) interfaces and application program interfaces (APIs).

Each of user system 810, application software system 830, training manager 850, event logging service 880, and data storage system 840 is implemented using at least one computing device that is communicatively coupled to electronic communications network 816. Any of user system 810, application software system 830, training manager 850, event logging service 880, and data storage system 840 can be bidirectionally communicatively coupled by network 816. User system 810 as well as other different user systems (not shown) can be bidirectionally communicatively coupled to application software system 830 and/or training manager 850.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 810, application software system 830, training manager 850, event logging service 880, and data storage system 840 are implemented using computer software, hardware, or software and hardware, and can include combinations of automated functionality, data structures, and digital data, which are represented schematically in the figures. User system 810, application software system 830, training manager 850, event logging service 880, and data storage system 840 are shown as separate elements in FIG. 8 for ease of discussion but, except as otherwise described, the illustration is not meant to imply that separation of these elements is required. The illustrated systems, services, and data stores (or their functionality) of each of user system 810, application software system 830, training manager 850, event logging service 880, and data storage system 840 can be divided over any number of physical systems, including a single physical computer system, and can communicate with each other in any appropriate manner.

FIG. 9 is an example of an entity graph in accordance with some embodiments of the present disclosure.

The entity graph 900 can be used by an application software system, e.g., to support a user connection network, in accordance with some embodiments of the present disclosure. The entity graph 900 can be used (e.g., queried or traversed) to obtain or generate input data (such as input data 106 described in FIG. 1), which is used by the prompt generator (e.g., prompt generator 120 described in FIG. 1) to generate a prompt input for a machine learning model (e.g., language model 150 described in FIG. 1).

An entity graph includes nodes, edges, and data (such as labels, weights, or scores) associated with nodes and/or edges. Nodes can be weighted based on, for example, edge counts or other types of computations, and edges can be weighted based on, for example, affinities, relationships, activities, similarities, or commonalities between the nodes connected by the edges, such as common attribute values (e.g., two users have the same job title or employer, or two users are n-degree connections in a user connection network).

A graphing mechanism is used to create, update and maintain the entity graph. In some implementations, the graphing mechanism is a component of the database architecture used to implement the entity graph 900. For instance, the graphing mechanism can be a component of data storage system 740 and/or application software system 730, shown in FIG. 7, and the entity graphs created by the graphing mechanism can be stored in one or more data stores of data storage system 740.

The entity graph 900 is dynamic (e.g., continuously updated) in that it is updated in response to occurrences of interactions between entities in an online system (e.g., a user connection network) and/or computations of new relationships between or among nodes of the graph. These updates are accomplished by real-time data ingestion and storage technologies, or by offline data extraction, computation, and storage technologies, or a combination of real-time and offline technologies. For example, the entity graph 900 is updated in response to user updates of user profiles, user connections with other users, and user creations of new content items, such as messages, posts, articles, comments, and shares.

The entity graph 900 includes a knowledge graph that contains cross-application links. For example, message activity data obtained from a messaging system can be linked with entities of the entity graph.

In the example of FIG. 9, entity graph 900 includes entity nodes, which represent entities, such as content item nodes (e.g., Article 1, Article 2, Comment U1), and user nodes (e.g., User 1, User 2, User 3, User 4, User 5). Entity graph 900 also includes characteristic nodes, which represent characteristics (e.g., profile data, topic data) of entities. Examples of characteristic nodes include title nodes (e.g., Title U1, Topic 1), company nodes (e.g., Company 1), topic nodes (Topic 1, Topic 2), and skill nodes (e.g., Skill 1).

Entity graph 900 also includes edges. The edges individually and/or collectively represent various different types of relationships between or among the nodes. Data can be linked with both nodes and edges. For example, when stored in a data store, each node is assigned a unique node identifier and each edge is assigned a unique edge identifier. The edge identifier can be, for example, a combination of the node identifiers of the nodes connected by the edge and a timestamp that indicates the date and time at which the edge was created. For instance, in the graph 900, edges between user nodes can represent online social connections between the users represented by the nodes, such as ‘friend’ or ‘follower’ connections between the connected nodes.

The graphic representation of nodes and edges provides information that can be used by a machine learning model (e.g., language model 150 described in FIG. 1 or fine-tuned language model 450 described in FIG. 4) to perform a domain-specific task. For example, values associated with user-selected attributes can be obtained from traversing the graph 900. Additionally or alternatively, traversing the nodes and edges of graph 900 can be used to interpret interest, represented by an affinity score. For instance, a user can be interested in a topic, a user can be interested in another user employed by a company, or a user can be interested in another user that has a certain skill. In the example entity graph 900, the user represented by the User 4 node clicked on the article represented by the Article 1 node by virtue of the CLICKED ON edge. Similarly, the user represented by the User 4 has viewed the article represented by the Article 2 node by virtue of the VIEWED edge, where both the Article 1 node and Article 2 node describe Topic 1 represented by the Topic 1 node, by virtue of the DESCRIBES edge. Accordingly, the traversal of the entity graph 900 indicates that User 1, represented by the User 1 node, has an interest in Topic 1, represented by the Topic 1 node.

Combinations of nodes and edges can be used to compute affinity scores or other scores used by various components of the machine learning model (e.g., language model 150 described in FIG. 1 or fine-tuned language model 450 described in FIG. 4) to perform a domain-specific task. For example, a score that measures the affinity of the user represented by the User 4 node to the Topic 1 represented by the Topic 1 node can be computed using a path p1 that includes a sequence of edges between the nodes User 4 and Article 2, and/or a path p2 that includes a sequence of edges between the nodes User 4 and Comment U1 and/or a path p3 that includes a sequence of edges between the nodes User 4 and Article 1. Any one or more of the paths p1, p2, p3 and/or other paths through the graph 900 can be used to compute scores that represent affinities, relationships, or statistical correlations between different nodes. For instance, based on relative edge counts, a user-topic affinity score computed between User 1 and Topic 1 might be higher than the user-topic affinity score computed between User 1 and Topic 2 (e.g., represented by path p4 that includes a sequence of edges between User 4, User 3, User 1, and Company 1). For instance, at least three paths p1,p2,p3 can be traversed between User 4 and Topic 1, whereas at least one path p4 can be traversed between User 4 and Topic 2, indicating a higher user-topic affinity score of Topic 1 with respect to Topic 2. Determining a user interest, representing by an affinity score, for instance, can personalize a task or a task type to be performed, for instance. For example, a fine-tuned machine learning model can generate personalized answers given User 4 interest and questions included in the prompt or encoded by the fine-tuned machine learning model.

In the entity graph 900, edges can represent activities involving the entities represented by the nodes connected by the edges. For example, a POSTED edge between the User 1 node and the Comment U1 node indicates that the user represented by the User 1 node posted the digital comment represented by the Comment U1 node to the application software system (e.g., as a comment involving Topic 1). Similarly. the CLICKED edge between the User 4 node and the Article 1 node indicates that the user represented by the User 4 node clicked on the article represented by the Article 1 node, and the LIKED edge between the User 4 node and the Comment U1 node indicates that the user represented by the User 4 node liked the content item represented by the Comment U1 node.

The examples shown in FIG. 9 and the accompanying description, above are provided for illustration purposes. This disclosure is not limited to the described examples.

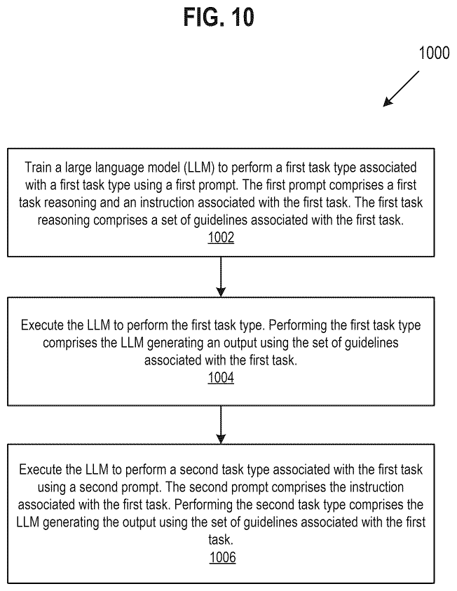

FIG. 10 is a flow diagram of an example method for training a large language model using reasoning distillation, in accordance with some embodiments of the present disclosure.

The method 1000 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 1000 is performed by one or more components of the training manager 850 of FIG. 8, or the training manager 108 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 1002, a processing device trains a large language model (LLM) to perform a first task type associated with a first task type using a first prompt. The first prompt comprises a first task reasoning and an instruction associated with the first task. The first task reasoning comprises a set of guidelines associated with the first task. For example, as described with reference to FIG. 2, the first prompt can be prompt 202 that includes an instruction associated with a summarization task (e.g., the first task) including general instruction 210, plan of action 212, constraint portion 214, and reasoning portion 218. The context portion 216 can indicate a particular type of input document such that the LLM is trained to perform a first task type.

At operation 1004, the processing device executes the LLM to perform the first task type. Performing the first task type comprises the LLM generating an output using the set of guidelines associated with the task. For example, the LLM can perform a summarization task (a first task) of a user profile (e.g., a first task type) to generate a user profile summary in accordance with summary guidelines (e.g., included in plan of action 212, constraint portion 214, and/or reasoning portion 218 of prompt 202 described in FIG. 2).

In some implementations, training the LLM to perform the first task associated with the first task type using the first prompt includes not training the LLM to perform the first task associated with the second task type. For example, the LLM receives a prompt (like prompt 202 described in FIG. 2) that includes a summarization task instruction (e.g., in the general instruction 210) and a user profile document (e.g., in the context portion 216). In some embodiments, the prompt may not include other types of input documents in the context portion 216. However, as described herein, the LLM develops statistical correlations during training that enable the LLM to perform the summarization task on other types of input documents (e.g., other task types).

At operation 1006, the processing device executes the LLM to perform a second task type associated with the task using a second prompt. The second prompt comprises the instruction associated with the task. Accordingly, the first prompt is a first size and the second prompt is a second size that is smaller than the first size. Performing the second task type comprises the LLM generating the output using the set of guidelines associated with the task. For example, a fine-tuned machine learning model can be generalized to perform a set of task types associated with a task. As described herein, training the machine learning model to perform a first task or a first task type develops statistical correlations that enable the machine learning model to perform a second task type (that is different from the first task type) that is related to the first task. Specifically, reasoning is distilled using the training prompts such that the machine learning model develops statistical correlations with respect to how to perform a task irrespective of the input document.

In some implementations, the processing devices trains the LLM to perform a second task using a third prompt including a second task reasoning and a second instruction associated with the second task. For example, after training the LLM to perform a first task type associated with a first task (such as a summarization of a news article), the LLM can be trained to perform a different task such as a classification task. To train the LLM to perform the second task, a different training prompt, such as a modified prompt 202 described in FIG. 2, is used with a second perspective portion 204, second body portion 206 (including a second general instruction 210, a second plan of action 212, a second constraints portion 214, second context portion 216, second reasoning portion 218, and in some instances a second few-shot example portion 208. The modified prompt 202 uses the plan of action or constraints associated with the performance of the second task (e.g., the classification task). After the LLM has been trained to perform the second task, the LLM is executed to perform the second task, wherein performing the second task includes the LLM generating a second output using the second task reasoning. For example, the LLM can generate a list of classified entities from a resume using a taxonomy included in the second plan of action.

In some implementations, training the LLM to perform the first task comprises generating a first training output associated with a first task confidence value, the first task confidence value satisfying a confidence threshold. That is, the first task is performed by the LLM at a confidence that satisfies a threshold degree of confidence or reliability. In some implementations, training the LLM to perform the second task comprises generating a second training output associated with a second task confidence value, the second task confidence value satisfying the confidence threshold. That is, the second task is performed by the LLM at a confidence that satisfies the threshold degree of confidence or reliability. As a result, training the LLM to perform the second task did not cause the LLM's performance of the first task to fail satisfying the confidence threshold.

In some implementations, the second task is dependent on the first task such that executing the LLM to perform the second task further comprises using the first task type output associated with the first task type or the second task type output associated with the second task type. For example, the first task and second task may be tasks of a task chain such that second tasks' performance is dependent on the output determined while performing the first task (e.g., the first task type or the second task type associated with the first task).

In some implementations, the first prompt further comprises one or more constraints to constrain the first task type output such that the first task type output uses the one or more constraints. For example, as described in FIG. 2, the prompt 202 can include a constraint portion 214 which constraints the output generated by the language model receiving the prompt 202. In some implementations, the second prompt does not comprise the one or more constraints to constrain the second task type output and the second task type output uses the one or more constraints. For example, as described in FIG. 5, the prompt 502 may not include a constraint portion similar to constraint portion 214 described in FIG. 2. However, the output generated by the language model receiving prompt 502 constrains the output as if the prompt 502 included constraints similar to those defined in constraint portion 214. This is a result of fine-tuning the language model using reasoning distillation such that the language model develops statistical correlations associated with performing the intermediate steps or logic associated with performing the task, including any constraints or guidelines associated with the task.

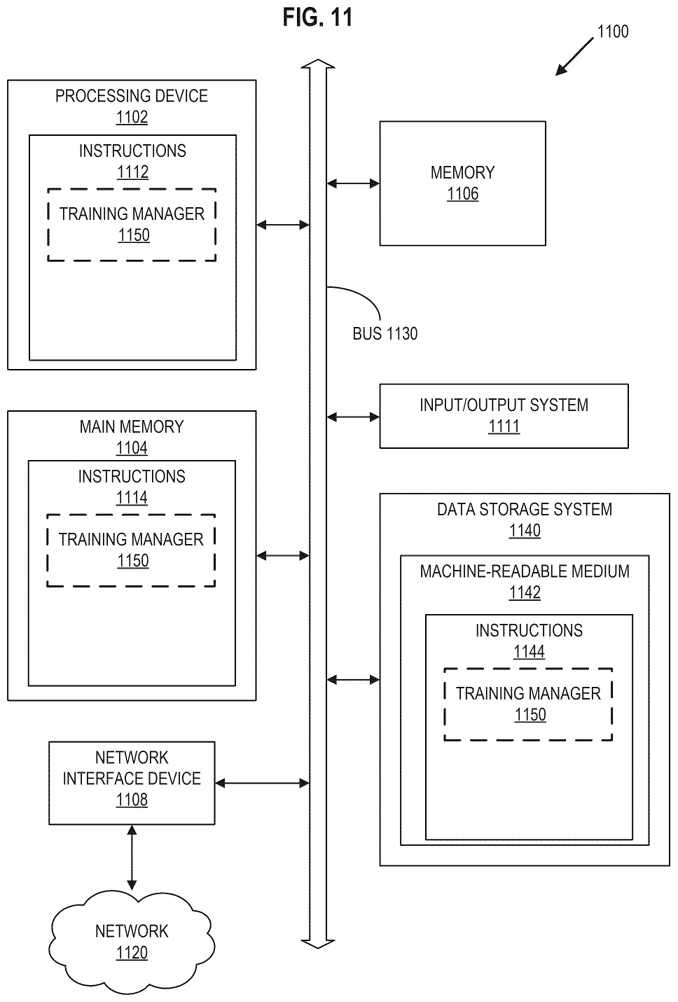

FIG. 11 is a block diagram of an example computer system including a training manager, in accordance with some embodiments of the present disclosure.

In FIG. 11, an example machine of a computer system 1100 is shown, within which a set of instructions for causing the machine to perform any of the methodologies discussed herein can be executed. In some embodiments, the computer system 1100 can correspond to a component of a networked computer system (e.g., as a component of the training manager 118 of FIG. 1 or the training manager 850 of FIG. 8) that includes, is coupled to, or utilizes a machine to execute an operating system to perform operations corresponding to one or more components of the training manager 118 of FIG. 1 or the training manager 850 of FIG. 8. For example, computer system 1100 corresponds to a portion of computing system 1100 when the computing system is executing a portion of the training manager 118 of FIG. 1.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM) or Rambus DRAM (RDRAM), etc.), a memory 1103 (e.g., flash memory, static random access memory (SRAM), etc.), an input/output system 1111, and a data storage system 1140, which communicate with each other via a bus 1130.

Processing device 1102 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 can also be at least one special-purpose processing device such as an application specific integrated circuit (ASIC), a field programmable gate array (FPGA), a digital signal processor (DSP), network processor, or the like. The processing device 1102 is configured to execute instructions 1112 for performing the operations and steps discussed herein.

In some embodiments of FIG. 11, training manager 1150 represents portions of training manager 850 of FIG. 8 and/or training manager 118 of FIG. 1 when the computer system 1100 is executing those portions of training manager 1150. Instructions 1112 include portions of the training manager 1150 when those portions of the training manager 1150 are being executed by processing device 1102. Thus, the training manager 1150 is shown in dashed lines as part of instructions 1112 to illustrate that, at times, portions of the training manager 1150 are executed by processing device 1102. For example, when at least some portion of the training manager 1150 is embodied in instructions to cause processing device 1102 to perform the method(s) described herein, some of those instructions can be read into processing device 1102 (e.g., into an internal cache or other memory) from main memory 1104 and/or data storage system 1140. However, it is not required that all of the training manager 1150 be included in instructions 1112 at the same time and portions of the training manager 1150 are stored in at least one other component of computer system 1100 at other times, e.g., when at least one portion of the training manager 1150 is not being executed by processing device 1102.

The computer system 1100 further includes a network interface device 1108 to communicate over the network 1120. Network interface device 1108 provides a two-way data communication coupling to a network. For example, network interface device 1108 can be an integrated-services digital network (ISDN) card, cable modem, satellite modem, or a modem to provide a data communication connection to a corresponding type of telephone line. As another example, network interface device 1108 can be a local area network (LAN) card to provide a data communication connection to a compatible LAN. Wireless links can also be implemented. In any such implementation network interface device 1108 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 1100.

Computer system 1100 can send messages and receive data, including program code, through the network(s) and network interface device 1108. In the Internet example, a server can transmit a requested code for an application program through the Internet and network interface device 1108. The received code can be executed by processing device 1102 as it is received, and/or stored in data storage system 1140, or other non-volatile storage for later execution.

The input/output system 1111 includes an output device, such as a display, for example a liquid crystal display (LCD) or a touchscreen display, for displaying information to a computer user, or a speaker, a haptic device, or another form of output device. The input/output system 1111 can include an input device, for example, alphanumeric keys and other keys configured for communicating information and command selections to processing device 1102. An input device can, alternatively or in addition, include a cursor control, such as a mouse, a trackball, or cursor direction keys for communicating direction information and command selections to processing device 1102 and for controlling cursor movement on a display. An input device can, alternatively or in addition, include a microphone, a sensor, or an array of sensors, for communicating sensed information to processing device 1102. Sensed information can include voice commands, audio signals, geographic location information, haptic information, and/or digital imagery, for example.

The data storage system 1140 includes a machine-readable storage medium 1142 (also known as a computer-readable medium) on which is stored at least one set of instructions 1144 or software embodying any of the methodologies or functions described herein. The instructions 1144 can also reside, completely or at least partially, within the main memory 1104 and/or within the processing device 1102 during execution thereof by the computer system 1100, the main memory 1104 and the processing device 1102 also constituting machine-readable storage media. In one embodiment, the instructions 1144 include instructions to implement functionality corresponding to the application software system 830 of FIG. 8 (e.g., training manager 118 of FIG. 1 or the training manager 1150 of FIG. 11).

Dashed lines are used in FIG. 11 to indicate that it is not required that the training manager 1150 be embodied entirely in instructions 1112, 1114, and 1144 at the same time. In one example, portions of the training manager 1150 are embodied in instructions 1114, which are read into main memory 1104 as instructions 1114, and portions of instructions 1112 are read into processing device 1102 as instructions 1112 for execution. In another example, some portions of the training manager 1150 are embodied in instructions 1144 while other portions are embodied in instructions 1114 and still other portions are embodied in instructions 1112.

While the machine-readable storage medium 1142 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 11 and the accompanying description above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 800, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Illustrative examples of the technologies disclosed herein are provided below. An embodiment of the technologies may include any of the examples described herein, or any combination of any of the examples described herein, or any combination of any portions of the examples described herein.

In some aspects, the techniques described herein relate to a method including: training a large language model (LLM) to perform a first task associated with a first task type using a first prompt including a first task reasoning and an instruction associated with the first task, wherein the first task reasoning includes a set of guidelines associated with the first task; executing the LLM to perform the first task type, wherein performing the first task type includes the LLM generating a first task type output using the set of guidelines associated with the first task; and executing the LLM to perform a second task type associated with the first task using a second prompt including the instruction associated with the first task, wherein performing the second task type includes the LLM generating a second task type output using the set of guidelines associated with the first task.

In some aspects, the techniques described herein relate to a method, wherein the first prompt is a first size and the second prompt is a second size, the second size being smaller than the first size.

In some aspects, the techniques described herein relate to a method, further including: training the LLM to perform a second task using a third prompt including a second task reasoning and a second instruction associated with the second task; and executing the LLM to perform the second task, wherein performing the second task includes the LLM generating a second output using the second task reasoning.

In some aspects, the techniques described herein relate to a method, wherein: training the LLM to perform the first task includes generating a first training output associated with a first task confidence value, the first task confidence value satisfying a confidence threshold, and training the LLM to perform the second task includes generating a second training output associated with a second task confidence value, the second task confidence value satisfying the confidence threshold.

In some aspects, the techniques described herein relate to a method, wherein the second task is dependent on the first task such that executing the LLM to perform the second task further includes using the first task type output associated with the first task type or the second task type output associated with the second task type.

In some aspects, the techniques described herein relate to a method, wherein the first prompt further includes one or more constraints to constrain the first task type output such that the first task type output uses the one or more constraints.

In some aspects, the techniques described herein relate to a method, wherein the second task type output uses the one or more constraints.

In some aspects, the techniques described herein relate to a system including: at least one processor: and at least one memory device coupled to the at least one processor, wherein the at least one memory device includes instructions that, when executed by the at least one processor, cause the at least one processor to perform at least one operation including: training a large language model (LLM) to perform a first task associated with a first task type using a first prompt including a first task reasoning and an instruction associated with the first task, wherein the first task reasoning includes a set of guidelines associated with the first task; executing the LLM to perform the first task type, wherein performing the first task type includes the LLM generating a first task type output using the set of guidelines associated with the first task; and executing the LLM to perform a second task type associated with the first task using a second prompt including the instruction associated with the first task, wherein performing the second task type includes the LLM generating a second task type output using the set of guidelines associated with the first task.

In some aspects, the techniques described herein relate to a system, wherein the first prompt is a first size and the second prompt is a second size, the second size being smaller than the first size.

In some aspects, the techniques described herein relate to a system, further including instructions that, when executed by the at least one processor, cause the at least one processor to perform at least one operation including: training the LLM to perform a second task using a third prompt including a second task reasoning and a second instruction associated with the second task; and executing the LLM to perform the second task, wherein performing the second task includes the LLM generating a second output using the second task reasoning.

In some aspects, the techniques described herein relate to a system, wherein: training the LLM to perform the first task includes generating a first training output associated with a first task confidence value, the first task confidence value satisfying a confidence threshold, and training the LLM to perform the second task includes generating a second training output associated with a second task confidence value, the second task confidence value satisfying the confidence threshold.

In some aspects, the techniques described herein relate to a system, wherein the second task is dependent on the first task such that executing the LLM to perform the second task further includes using the first task type output associated with the first task type or the second task type output associated with the second task type.

In some aspects, the techniques described herein relate to a system, wherein the first prompt further includes one or more constraints to constrain the first task type output such that the first task type output uses the one or more constraints.

In some aspects, the techniques described herein relate to a system, wherein the second task type output uses the one or more constraints.

In some aspects, the techniques described herein relate to a non-transitory machine-readable storage medium including instructions that, when executed by at least one processor, cause the at least one processor to perform at least one operation including: training a large language model (LLM) to perform a first task associated with a first task type using a first prompt including a first task reasoning and an instruction associated with the first task, wherein the first task reasoning includes a set of guidelines associated with the first task; executing the LLM to perform the first task type, wherein performing the first task type includes the LLM generating a first task type output using the set of guidelines associated with the first task; and executing the LLM to perform a second task type associated with the first task using a second prompt including the instruction associated with the first task, wherein performing the second task type includes the LLM generating a second task type output using the set of guidelines associated with the first task.

In some aspects, the techniques described herein relate to a non-transitory machine-readable storage medium, wherein the first prompt is a first size and the second prompt is a second size, the second size being smaller than the first size.

In some aspects, the techniques described herein relate to a non-transitory machine-readable storage medium, further including instructions that, when executed by at least one processor, cause the at least one processor to perform at least one operation including: training the LLM to perform a second task using a third prompt including a second task reasoning and a second instruction associated with the second task; and executing the LLM to perform the second task, wherein performing the second task includes the LLM generating a second output using the second task reasoning.

In some aspects, the techniques described herein relate to a non-transitory machine-readable storage medium, wherein: training the LLM to perform the first task includes generating a first training output associated with a first task confidence value, the first task confidence value satisfying a confidence threshold, and training the LLM to perform the second task includes generating a second training output associated with a second task confidence value, the second task confidence value satisfying the confidence threshold.

In some aspects, the techniques described herein relate to a non-transitory machine-readable storage medium, wherein the second task is dependent on the first task such that executing the LLM to perform the second task further includes using the first task type output associated with the first task type or the second task type output associated with the second task type.

In some aspects, the techniques described herein relate to a non-transitory machine-readable storage medium, wherein: the first prompt further includes one or more constraints to constrain the first task type output such that the first task type output uses the one or more constraints.

Clause 1. A method comprising: training a large language model (LLM) to perform a first task associated with a first task type using a first prompt comprising a first task reasoning and an instruction associated with the first task, wherein the first task reasoning comprises a set of guidelines associated with the first task; executing the LLM to perform the first task type, wherein performing the first task type comprises the LLM generating a first task type output using the set of guidelines associated with the first task; and executing the LLM to perform a second task type associated with the first task using a second prompt comprising the instruction associated with the first task, wherein performing the second task type comprises the LLM generating a second task type output using the set of guidelines associated with the first task.

Clause 2. The method of clause 1, wherein the first prompt is a first size and the second prompt is a second size, the second size being smaller than the first size.

Clause 3. The method of clause 1 or claims 2, further comprising: training the LLM to perform a second task using a third prompt comprising a second task reasoning and a second instruction associated with the second task; and executing the LLM to perform the second task, wherein performing the second task comprises the LLM generating a second output using the Clause 4. The method of any of clauses 1-3, wherein: training the LLM to perform the first task comprises generating a first training output associated with a first task confidence value, the first task confidence value satisfying a confidence threshold, and training the LLM to perform the second task comprises generating a second training output associated with a second task confidence value, the second task confidence value satisfying the confidence threshold.

Clause 5. The method of any of clauses 1-4, wherein the second task is dependent on the first task such that executing the LLM to perform the second task further comprises using the first task type output associated with the first task type or the second task type output associated with the second task type.

Clause 6. The method of any of clauses 1-5, wherein the first prompt further comprises one or more constraints to constrain the first task type output such that the first task type output uses the one or more constraints.

Clause 7. The method of any of clauses 1-6, wherein the second task type output uses the one or more constraints.

Clause 8. A system comprising: at least one processor: and at least one memory device coupled to the at least one processor, wherein the at least one memory device comprises instructions that, when executed by the at least one processor, cause the at least one processor to perform at least one operation comprising: training a large language model (LLM) to perform a first task associated with a first task type using a first prompt comprising a first task reasoning and an instruction associated with the first task, wherein the first task reasoning comprises a set of guidelines associated with the first task; executing the LLM to perform the first task type, wherein performing the first task type comprises the LLM generating a first task type output using the set of guidelines associated with the first task; and executing the LLM to perform a second task type associated with the first task using a second prompt comprising the instruction associated with the first task, wherein performing the second task type comprises the LLM generating a second task type output using the set of guidelines associated with the first task.

Clause 9. The system of clause 8, wherein the first prompt is a first size and the second prompt is a second size, the second size being smaller than the first size.

Clause 10. The system of clause 8 or clause 9, further comprising instructions that, when executed by the at least one processor, cause the at least one processor to perform at least one operation comprising: training the LLM to perform a second task using a third prompt comprising a second task reasoning and a second instruction associated with the second task; and executing the LLM to perform the second task, wherein performing the second task comprises the LLM generating a second output using the second task reasoning.

Clause 11. The system of any of clauses 8-10, wherein: training the LLM to perform the first task comprises generating a first training output associated with a first task confidence value, the first task confidence value satisfying a confidence threshold, and training the LLM to perform the second task comprises generating a second training output associated with a second task confidence value, the second task confidence value satisfying the confidence threshold.

Clause 12. The system of any of clauses 8-11, wherein the second task is dependent on the first task such that executing the LLM to perform the second task further comprises using the first task type output associated with the first task type or the second task type output associated with the second task type.

Clause 13. The system of any of clauses 8-12, wherein the first prompt further comprises one or more constraints to constrain the first task type output such that the first task type output uses the one or more constraints.

Clause 14. The system of any of clauses 8-13, wherein the second task type output uses the one or more constraints.

Clause 15. A non-transitory machine-readable storage medium comprising instructions that, when executed by at least one processor, cause the at least one processor to perform at least one operation comprising: training a large language model (LLM) to perform a first task associated with a first task type using a first prompt comprising a first task reasoning and an instruction associated with the first task, wherein the first task reasoning comprises a set of guidelines associated with the first task; executing the LLM to perform the first task type, wherein performing the first task type comprises the LLM generating a first task type output using the set of guidelines associated with the first task; and executing the LLM to perform a second task type associated with the first task using a second prompt comprising the instruction associated with the first task, wherein performing the second task type comprises the LLM generating a second task type output using the set of guidelines associated with the first task.

Clause 16. The non-transitory machine-readable storage medium of clause 15, wherein the first prompt is a first size and the second prompt is a second size, the second size being smaller than the first size.

Clause 17. The non-transitory machine-readable storage medium of clause 15 or clause 16, further comprising instructions that, when executed by at least one processor, cause the at least one processor to perform at least one operation comprising: training the LLM to perform a second task using a third prompt comprising a second task reasoning and a second instruction associated with the second task; and executing the LLM to perform the second task, wherein performing the second task comprises the LLM generating a second output using the second task reasoinging.

Clause 18. The non-transitory machine-readable storage medium of any of clauses 15-17, wherein: training the LLM to perform the first task comprises generating a first training output associated with a first task confidence value, the first task confidence value satisfying a confidence threshold, and training the LLM to perform the second task comprises generating a second training output associated with a second task confidence value, the second task confidence value satisfying the confidence threshold.

Clause 19. The non-transitory machine-readable storage medium of any of clauses 15-18, wherein the second task is dependent on the first task such that executing the LLM to perform the second task further comprises using the first task type output associated with the first task type or the second task type output associated with the second task type.

Clause 20. The non-transitory machine-readable storage medium of any of clauses 15-19, wherein: the first prompt further comprises one or more constraints to constrain the first task type output such that the first task type output uses the one or more constraints.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
training a large language model (LLM) to perform a first task associated with a first task type using a first prompt comprising a first task reasoning and an instruction associated with the first task, wherein the first task reasoning comprises a set of guidelines associated with the first task;
executing the LLM to perform the first task type, wherein performing the first task type comprises the LLM generating a first task type output using the set of guidelines associated with the first task; and
executing the LLM to perform a second task type associated with the first task using a second prompt comprising the instruction associated with the first task, wherein performing the second task type comprises the LLM generating a second task type output using the set of guidelines associated with the first task.

2. The method of claim 1, wherein the first prompt is a first size and the second prompt is a second size, the second size being smaller than the first size.

3. The method of claim 1, further comprising:
training the LLM to perform a second task using a third prompt comprising a second task reasoning and a second instruction associated with the second task; and
executing the LLM to perform the second task, wherein performing the second task comprises the LLM generating a second output using the second task reasoning.

4. The method of claim 3, wherein:
training the LLM to perform the first task comprises generating a first training output associated with a first task confidence value, the first task confidence value satisfying a confidence threshold, and
training the LLM to perform the second task comprises generating a second training output associated with a second task confidence value, the second task confidence value satisfying the confidence threshold.

5. The method of claim 3, wherein the second task is dependent on the first task such that executing the LLM to perform the second task further comprises using the first task type output associated with the first task type or the second task type output associated with the second task type.

6. The method of claim 1, wherein the first prompt further comprises one or more constraints to constrain the first task type output such that the first task type output uses the one or more constraints.

7. The method of claim 6, wherein the second task type output uses the one or more constraints.

8. A system comprising:
at least one processor; and
at least one memory device coupled to the at least one processor, wherein the at least one memory device comprises instructions that, when executed by the at least one processor, cause the at least one processor to perform at least one operation comprising:
training a large language model (LLM) to perform a first task associated with a first task type using a first prompt comprising a first task reasoning and an instruction associated with the first task, wherein the first task reasoning comprises a set of guidelines associated with the first task;
executing the LLM to perform the first task type, wherein performing the first task type comprises the LLM generating a first task type output using the set of guidelines associated with the first task; and
executing the LLM to perform a second task type associated with the first task using a second prompt comprising the instruction associated with the first task, wherein performing the second task type comprises the LLM generating a second task type output using the set of guidelines associated with the first task.

9. The system of claim 8, wherein the first prompt is a first size and the second prompt is a second size, the second size being smaller than the first size.

10. The system of claim 8, further comprising instructions that, when executed by the at least one processor, cause the at least one processor to perform at least one operation comprising:
training the LLM to perform a second task using a third prompt comprising a second task reasoning and a second instruction associated with the second task; and
executing the LLM to perform the second task, wherein performing the second task comprises the LLM generating a second output using the second task reasoning.

11. The system of claim 10, wherein:
training the LLM to perform the first task comprises generating a first training output associated with a first task confidence value, the first task confidence value satisfying a confidence threshold, and
training the LLM to perform the second task comprises generating a second training output associated with a second task confidence value, the second task confidence value satisfying the confidence threshold.

12. The system of claim 10, wherein the second task is dependent on the first task such that executing the LLM to perform the second task further comprises using the first task type output associated with the first task type or the second task type output associated with the second task type.

13. The system of claim 8, wherein the first prompt further comprises one or more constraints to constrain the first task type output such that the first task type output uses the one or more constraints.

14. The system of claim 13, wherein the second task type output uses the one or more constraints.

15. A non-transitory machine-readable storage medium comprising instructions that, when executed by at least one processor, cause the at least one processor to perform at least one operation comprising:
training a large language model (LLM) to perform a first task associated with a first task type using a first prompt comprising a first task reasoning and an instruction associated with the first task, wherein the first task reasoning comprises a set of guidelines associated with the first task;
executing the LLM to perform the first task type, wherein performing the first task type comprises the LLM generating a first task type output using the set of guidelines associated with the first task; and
executing the LLM to perform a second task type associated with the first task using a second prompt comprising the instruction associated with the first task, wherein performing the second task type comprises the LLM generating a second task type output using the set of guidelines associated with the first task.

16. The non-transitory machine-readable storage medium of claim 15, wherein the first prompt is a first size and the second prompt is a second size, the second size being smaller than the first size.

17. The non-transitory machine-readable storage medium of claim 15, further comprising instructions that, when executed by at least one processor, cause the at least one processor to perform at least one operation comprising:
training the LLM to perform a second task using a third prompt comprising a second task reasoning and a second instruction associated with the second task; and
executing the LLM to perform the second task, wherein performing the second task comprises the LLM generating a second output using the second task reasoning.

18. The non-transitory machine-readable storage medium of claim 17, wherein:
training the LLM to perform the first task comprises generating a first training output associated with a first task confidence value, the first task confidence value satisfying a confidence threshold, and
training the LLM to perform the second task comprises generating a second training output associated with a second task confidence value, the second task confidence value satisfying the confidence threshold.

19. The non-transitory machine-readable storage medium of claim 17, wherein the second task is dependent on the first task such that executing the LLM to perform the second task further comprises using the first task type output associated with the first task type or the second task type output associated with the second task type.

20. The non-transitory machine-readable storage medium of claim 15, wherein:
the first prompt further comprises one or more constraints to constrain the first task type output such that the first task type output uses the one or more constraints.
